(19) United States
(12) Patent Application Publication
(10) Pub. No.: US 2015/0360750 A1
(43) Pub. Date: Dec. 17, 2015

(54) VARIABLE TRANSMISSION GEARING SYSTEM

(71) Applicant: Mega Unit Technology Limited, Hong Kong (HK)

(72) Inventors: Kim Leung Luk, Hong Kong (HK); Yam Ho Yeung, Hong Kong (HK)

(73) Assignee: MEGA UNIT TECHNOLOGY LIMITED

(21) Appl. No.: 14/732,823

(22) Filed: Jun. 8, 2015

Related U.S. Application Data
(60) Provisional application No. 62/011,024, filed on Jun. 11, 2014.

(51) Int. Cl. B62M 11/16; F16H 3/50; F16H 61/02; F16H 3/72; B62M 9/06; F16H 59/36

(52) U.S. Cl. CPC B62M 11/16; B62M 9/06; F16H 59/36; F16H 61/0202; F16H 3/72; F16H 3/50; B62M 2701/0046

(57) ABSTRACT

A variable transmission gearing system for a bicycle includes a mainboard driven by a chain gear, a plurality of cone gears rotatable on a plurality of shafts fixed on the mainboard respectively, and a sun gear rotatable with an input shaft of a wheel. Also disclosed is a variable transmission gearing system including a sprocket mounted on a sprocket mount, a cone driver rotatable with the sprocket mount, a plurality of cone gears rotatably mounted between the cone driver and a cone holder, a driven pad frictionally engaged and rotatable with the cone gears, a main shaft rotatable with the driven pad, and a shifting shaft frictionally engaged and rotatable with the cone gears.

### CROSS-REFERENCE TO RELATED APPLICATIONS

This application claims the benefit of U.S. Provisional Patent Application No. 62/011,024, filed Jun. 11, 2014, the entire content of which is hereby incorporated by reference.

### FIELD OF THE TECHNOLOGY

The present application is directed to a gearing system, and specifically to a smart variable transmission gearing system for bicycle.

### BACKGROUND

Bicycles are usually provided with several gear ratios so that a rider can shift back and forth between gears to efficiently operate the bicycle under various riding conditions. However, it is difficult to shift back and forth among a large number of gear ratios, and the rider may use only a few of the gear ratios which are available.

It is beneficial to have as many gear ratios as possible, but then the structure of the bicycle becomes very complicated and heavy. Hence, it is desired to have a bicycle with an indefinite variable gear ratio, and it is particularly desirable to have such a variable gear ratio operate automatically, so the rider need not have to worry about changing gears during bike riding. Even after one has provided an infinite variable gear ratio which is automatic, one will still wish to control the gear ratio in a more effective and user-friendly way.

Therefore, it is desirable to provide a smart variable transmission gearing system for bicycles which is more simple and easy to operate, allows gears to be shifted automatically and/or manually, and can be more humanized and interactive through the use of mobile phone apps and internet.

### SUMMARY

According to one aspect, there is provided a variable transmission gearing system for a bicycle which may include a mainboard driven by a chain gear, and a plurality of cone gears rotatable on a plurality of shafts fixed on the mainboard respectively. Each cone gear may include a ratio gear and a driven gear. The driven gear can be meshed with a first internal spur gear mounted in a gear box. The system may also include a central sun gear rotatable with an input shaft of a wheel for driving the wheel to rotate. The sun gear can be meshed with the ratio gears of the cone gears, and adapted to be shifted in an axle direction along the input shaft by a plurality of threaded rods. When the chain gear is rotated anticlockwise, the mainboard and the cone gears rotate anticlockwise and drive the sun gear and the input shaft to rotate clockwise.

The variable transmission gearing system may further include a set of magnetic clutch gears meshed with a set of intermediate gears for driving the threaded rods. The magnetic clutch gears may include a shifting gear and fixed gear sandwiched between first and second coils and rotatable on a pin fixed on the mainboard. The first coil can be fixed on the mainboard. The fixed gear can be mounted on the second coil and meshed with the first internal spur gear. The shifting gear may be shiftable along the pin between the fixed gear and the first coil. When the shifting gear is paired with the fixed gear, the shifting gear rotates anticlockwise and drives the threaded rods to rotate anticlockwise so that the sun gear moves towards the mainboard, and when the shifting gear is paired with the lower coil, the threaded rods rotate clockwise, and the sun gear moves away from the mainboard.

In one embodiment, the set of intermediate gears may include an outer gear meshed with the shifting gear, a ring gear having outer teeth meshed with the outer gear and inner teeth meshed with an inner gear fixed on each threaded rod.

The variable transmission gearing system may further include one or more generators. Each generator may have a gear meshed with a second internal spur gear mounted in the gear box to generate electricity.

The variable transmission gearing system may further include a speedometer for collecting rotational speed data which will be transmitted to a mobile phone app for calculation and control of the sun gear. A Bluetooth controller may be used to carry out control and data transmitting requests.

The variable transmission gearing system may further include a built-in machine control unit which is set with a program to control position of the sun gear.

The variable transmission gearing system may further include a mobile phone app adapted to carry out real time analysis of data including speed, slope and position of the sun gear detected by a sensor in order to control the position of the sun gear.

In one embodiment, a plurality of bearings can be provided between the mainboard and the input shaft. Three cone gears may be rotatable on three shafts fixed on the mainboard respectively.

According to another aspect, there is provided a variable transmission gearing system for a bicycle which may include a sprocket mounted on a sprocket mount, a cone driver rotatable with the sprocket mount, and a plurality of cone gears rotatably mounted between the cone driver and a cone holder coupled with the cone driver. Each cone gear may include a major conical surface and a minor frusto-conical surface formed at a larger end of the major conical surface. A driven pad may be frictionally engaged and rotatable with the frusto-conical surfaces of the cone gears. The system may further include a main shaft of a wheel rotatable with the driven pad, and a shifting shaft having at one end thereof an outwardly extending annular flange frictionally engaged and rotatable with the conical surfaces of the cone gears at a plurality of contact points. The shifting shaft may be shiftable in an axle direction by a set of gears to thereby change the position of the contact points.

In one embodiment, the set of gears may include an internal gear having external threads threadably engaged with internal threads formed in the shifting shaft, a motor gear driven by a motor and meshed between the internal gear and a central gear. When the motor is activated to drive the motor gear to rotate clockwise, the internal gear rotates clockwise and the shifting shaft shifts away from the cone holder, and when the motor is activated to drive the motor gear to rotate anticlockwise, the internal gear rotates anticlockwise and the shifting shaft shifts towards the cone holder.

In one embodiment, the main shaft of the wheel can be rotatable with the driven pad through a driven mount coupled with the driven pad. The driven mount may be coupled with the main shaft through a satellite gearing system. The satellite gearing system may include a satellite driving gear attached to the driven mount, a plurality of satellite driven gears rotatable respectively about a plurality of supplementary shafts fixed on a plurality of blades extending radially from the main shaft, and a satellite internal gear mounted in a housing. The driving gear is adapted to mesh with and drive the driven gears meshing with the satellite internal gear.

In one embodiment, the sprocket mount may be annular and formed with a plurality of openings, and the cone driver may be coupled with the sprocket mount by a plurality of balls provided thereinbetween.

In one embodiment, a plurality of rods can be fixed to the cone holder and the free ends of the rods can be inserted into corresponding holes formed on the cone driver to form a plurality of free-end joints for joining the cone holder to the cone driver.

The variable transmission gearing system may further include a speedometer for collecting rotational speed data which will be transmitted to a mobile phone app for calculation and control of the shifting gear.

The variable transmission gearing system may further include a built-in machine control unit which is set with a program to control position of the shifting shaft by sending signals to the motor to rotate the motor gear clockwise or anticlockwise.

The variable transmission gearing system may further include a mobile phone app adapted to carry out real time analysis of data including speed, slope and position of the shifting shaft detected by a sensor in order to control position of the shifting shaft.

In one embodiment, the variable transmission gearing system may further include at least one more gear meshed between the internal gear and the central gear.

Although the variable transmission gearing system is shown and described with respect to certain embodiments, it is obvious that equivalents and modifications will occur to others skilled in the art upon the reading and understanding of the specification. The variable transmission gearing system in the present application includes all such equivalents and modifications, and is limited only by the scope of the claims.

### BRIEF DESCRIPTION OF THE DRAWINGS

Specific embodiments of the variable transmission gearing system will now be described by way of example with reference to the accompanying drawings wherein:

FIG. 1A is a front view of a gear box of the variable transmission gearing system according to a first embodiment of the present application.

FIG. 1B is a side view of the gear box of the variable transmission gearing system.

FIG. 1C is a rear perspective view of the gear box of the variable transmission gearing system.

FIG. 1D is a front perspective view of the gear box of the variable transmission gearing system.

FIG. 2A shows a side view and a cross sectional view taken along line A-A of the gear box of the variable transmission gearing system.

FIG. 2B shows a front view and two cross sectional views taken along lines A-A and B-B of the gear box of the variable transmission gearing system.

FIG. 2C shows a side view and two cross sectional views taken along lines A-A and C-C of the gear box of the variable transmission gearing system.

FIG. 2D shows a side view and two cross sectional views taken along lines A-A and D-D of the gear box of the variable transmission gearing system.

FIG. 2E shows a side view and two cross sectional views taken along lines A-A and E-E of the gear box of the variable transmission gearing system.

FIG. 2F shows a side view and two cross sectional views taken along lines A-A and F-F of the gear box of the variable transmission gearing system.

FIG. 2G shows a side view and two cross sectional views taken along lines A-A and G-G of the gear box of the variable transmission gearing system.

FIG. 2H shows a side view and two cross sectional views taken along lines A-A and H-H of the gear box of the variable transmission gearing system.

FIG. 3A is a rear perspective view of the gear box of the variable transmission gearing system.

FIG. 3B is a front perspective view of the gear box of the variable transmission gearing system.

FIG. 4A is a rear perspective view of a housing of the gear box.

FIG. 4B is a front perspective view of a housing of the gear box.

FIG. 5A shows front and rear perspective views of a control arm according to an embodiment of the present application.

FIG. 5B shows front perspective and side views of a speedometer according to the first embodiment of the present application.

FIG. 6A is a rear perspective view showing the internal structures of the variable transmission gearing system according to the first embodiment of the present application.

FIG. 6B is a front perspective view showing the internal structures of the variable transmission gearing system according to the first embodiment of the present application.

FIG. 6C shows front and perspective views of a sprocket gear according to the first embodiment of the present application.

FIG. 7 shows the two positions of the shifting gears according to the first embodiment of the present application.

FIG. 8 shows side, front and rear perspective views of the sun gear and the threaded rods mounted on the input shaft.

FIG. 9 shows two exploded views of the variable transmission gearing system according to the first embodiment of the present application.

FIG. 10 is a side view of a rear part of a bicycle frame with the variable transmission gearing system installed thereon.

FIG. 11 is a perspective view of a rear part of a bicycle frame with the variable transmission gearing system installed thereon.

FIG. 12 is front perspective view of the variable transmission gearing system.

FIG. 13 is a front perspective view of the variable transmission gearing system with the gear box being removed.

FIG. 14 shows perspective and side views of a cone gear according to the first embodiment of the present application.

FIG. 15 is a front view of the variable transmission gearing system with parts being removed to show the rotation of the mainboard, the cone gears and the sun gear according to the first embodiment of the present application.

FIG. 16 shows the shifting movement of the sun gear along the input shaft according to the first embodiment of the present application.

FIG. 17 is a front view of the variable transmission gearing system with parts being removed to show the rotation of the mainboard and the fixed gear according to the first embodiment of the present application.

FIG. 18 is a front view of the variable transmission gearing system with parts being removed to show two cases of the shifting movement of the shifting shaft according to the first embodiment of the present application.

FIG. 19 is a front view of the variable transmission gearing system with parts being removed to show the generators according to the first embodiment of the present application.

FIG. 20 is a flow chart showing the operation of the variable transmission gearing system with mobile connection according to the first embodiment of the present application.

FIG. 21 is a flow chart showing the operation of the variable transmission gearing system without mobile connection according to the first embodiment of the present application.

FIG. 22 is a front view of a gear box of the variable transmission gearing system according to a second embodiment of the present application.

FIG. 23 is a side view of the gear box of the variable transmission gearing system.

FIG. 24 is a front perspective view of the gear box of the variable transmission gearing system.

FIG. 25 is a rear perspective view of the gear box of the variable transmission gearing system.

FIG. 26a is a side view of the gear box of the variable transmission gearing system.

FIG. 26b is a cross sectional view taken along line A-A of the gear box of the variable transmission gearing system of FIG. 26a.

FIG. 27a is a side view of the gear box of the variable transmission gearing system.

FIG. 27b is a cross sectional view taken along line B-B of the gear box of the variable transmission gearing system of FIG. 27a.

FIG. 28a is a side view of the gear box of the variable transmission gearing system.

FIG. 28b is a cross sectional view taken along line C-C of the gear box of the variable transmission gearing system of FIG. 28a.

FIG. 29a is a side view of the gear box of the variable transmission gearing system.

FIG. 29b is a cross sectional view taken along line D-D of the gear box of the variable transmission gearing system of FIG. 29a.

FIG. 30 shows the two shifting directions of the shifting shaft of the variable transmission gearing system according to the second embodiment of the present application.

FIG. 31 shows perspective, rear and cross sectional (along line E-E) views of the variable transmission gearing system according to the second embodiment of the present application.

FIG. 32 is a perspective view of a satellite gearing system according to the second embodiment of the present application.

FIG. 33a is an exploded front perspective view of the variable transmission gearing system according to the second embodiment of the present application.

FIG. 33b is an exploded rear perspective view of the variable transmission gearing system according to the second embodiment of the present application.

FIG. 34 is an exploded rear perspective view of the variable transmission gearing system according to the second embodiment of the present application (FIG. 341 shows the satellite gears; FIG. 342 shows the SVT system; FIG. 343 shows the shifting gears).

FIG. 35 is a flow chart showing the operation of the variable transmission gearing system with mobile connection according to the second embodiment of the present application.

FIG. 36 is a flow chart showing the operation of the variable transmission gearing system without mobile connection according to the second embodiment of the present application.

### DETAILED DESCRIPTION

Reference will now be made in detail to a preferred embodiment of the variable transmission gearing system, examples of which are also provided in the following description. Exemplary embodiments of the variable transmission gearing system are described in detail, although it will be apparent to those skilled in the relevant art that some features that are not particularly important to an understanding of the variable transmission gearing system may not be shown for the sake of clarity.

It should be noted that throughout the specification and claims herein, when one element is said to be “coupled” or “connected” to another, this does not necessarily mean that one element is fastened, secured, or otherwise attached to another element. Instead, the term “coupled” or “connected” means that one element is either connected directly or indirectly to another element or is in mechanical or electrical communication with another element.

Smart variable transmission (SVT) is a gearing system for bicycles. It is equipped with manual and automatic gear shifting functions that fit for most of the traditional type of bicycle using either chain or belt.

The gear box of the SVT is constructed by using all-in-one and easy to install concept. Customers are not required to buy a special designed bicycle but only remove the traditional gear box and replace it with the SVT gear box. No wire, welding, or complicated modification is required.

Using SVT gear box instead of traditional gear box, troublesome on alternating gears can be reduced. Therefore efficiency of bicycles can be improved; and energy won't be easily wasted due to inappropriate use of gear ratio.

Once the SVT gearing system is installed, a user no longer needs to worry about what gear is using. The default mode for the gearing system is automatic, and speed data will be taken and calculated through a micro-controlling unit (MCU). Appropriate gear ratio will be shifted automatically so that user can ride under the most efficient gear ratio all the time.

For using the SVT gearing system in manual controlling mode, a mini-controller can be used by attaching it to anywhere that can be accessed easily. The controller provides three main buttons, namely “Mode”, “UP” and “DOWN”. Users can change any gear ratio by pressing the “UP” or “DOWN” button while pressing the “Mode” button for alternating manual or automatic mode.

For upgrading the function of the SVT gearing system, apps can be provided for iphone and android by connecting a mobile to the SVT gearing system. With connection to the mobile, mobile will take over the role of MCU to control the SVT gearing system. Much more data and analysis can be processed and recorded by the mobile. Several upgrading functions include SVT gear shifting modes, SVT status checking, user's riding habit recording, tasks etc.

For gear shifting modes, firstly three modes, namely “Standard”, “Relax” and “Race” can be provided. According to the mode, a user may choose the sensitive, resolution, and rate of the gear shifting. Apps will continuous to take data from a sensor and shift the gear accordingly.

SVT status such as fault checking, battery, running gear ratio, speed etc., can be checked through the apps designed by the user.

As the SVT gearing system is equipped with mini-generators for converting biological energy to electrical, battery can be charged by itself. In fact no battery change is needed. Two LEDs can be attached to the SVT gearing system. Once the mobile has been connected, the LEDs will be grown at night for safety purpose. A user can switch the LEDs off using the app.

To install, a user can remove the traditional gear box, and replace it by a SVT gear box. The SVT gear box can be locked by using specially designed screw and locker.

### First Embodiment

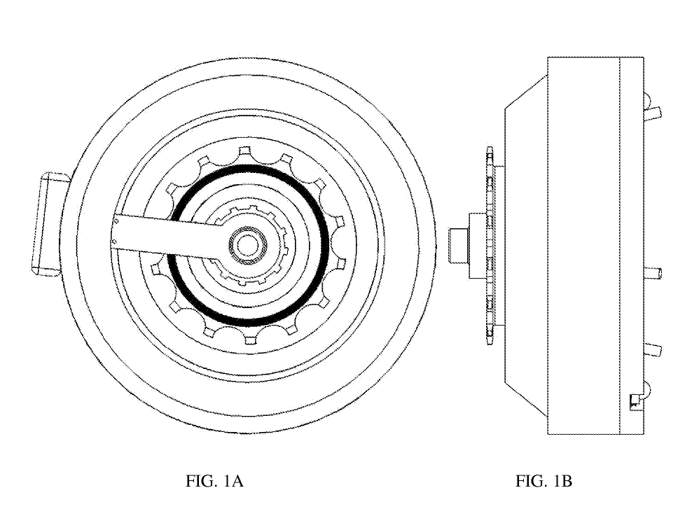

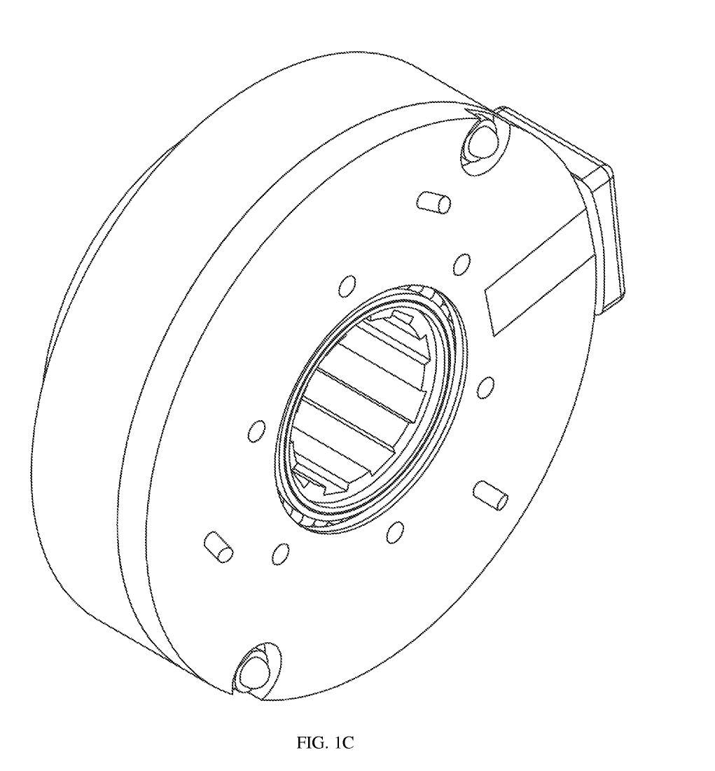

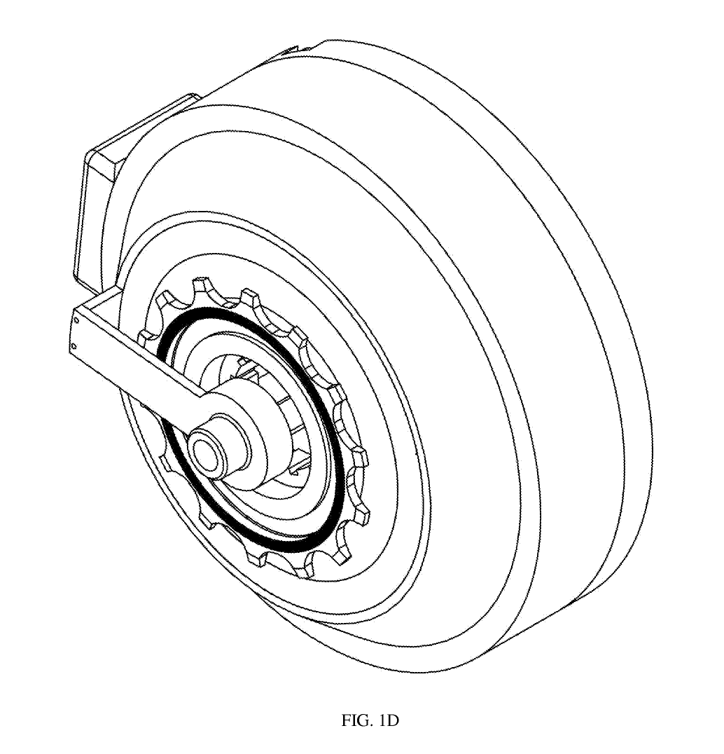

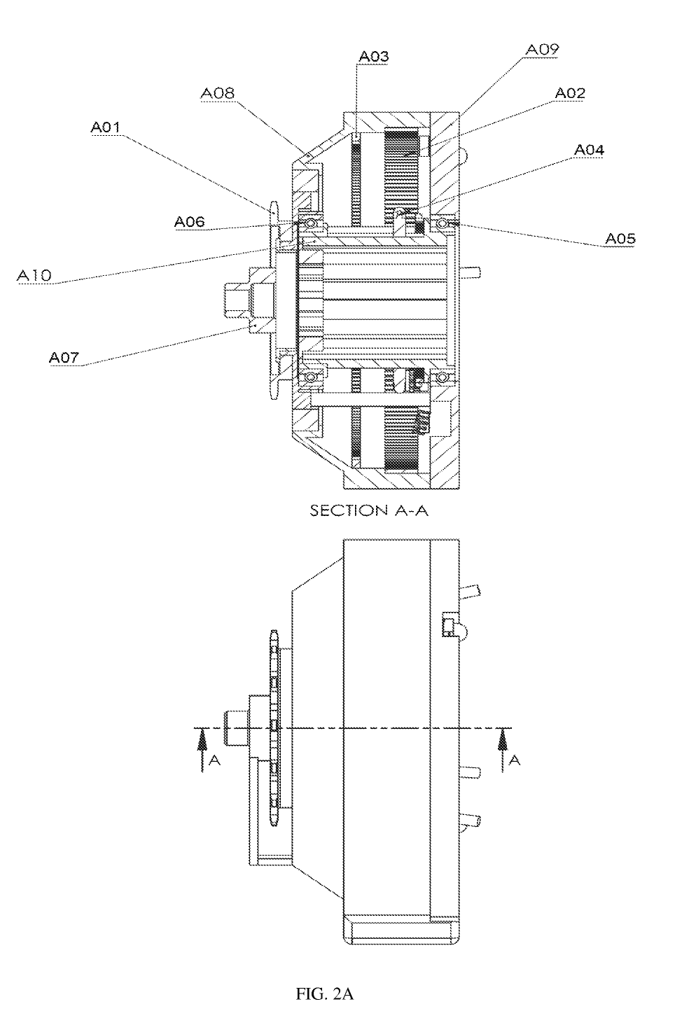

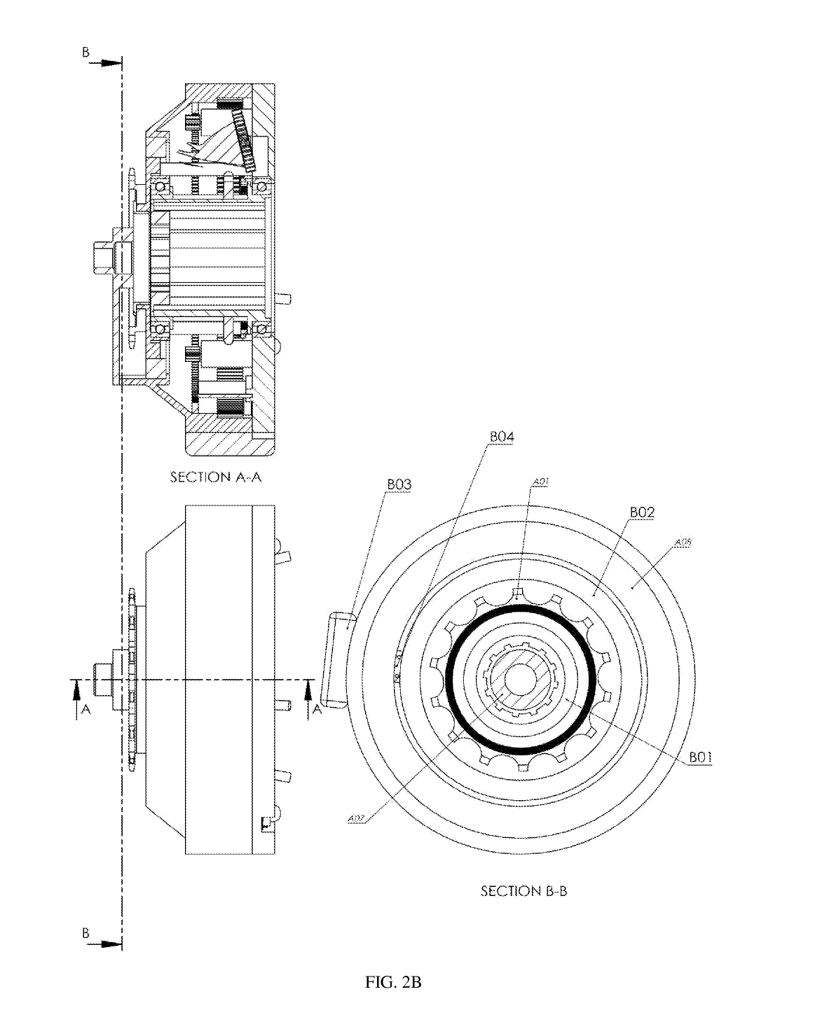

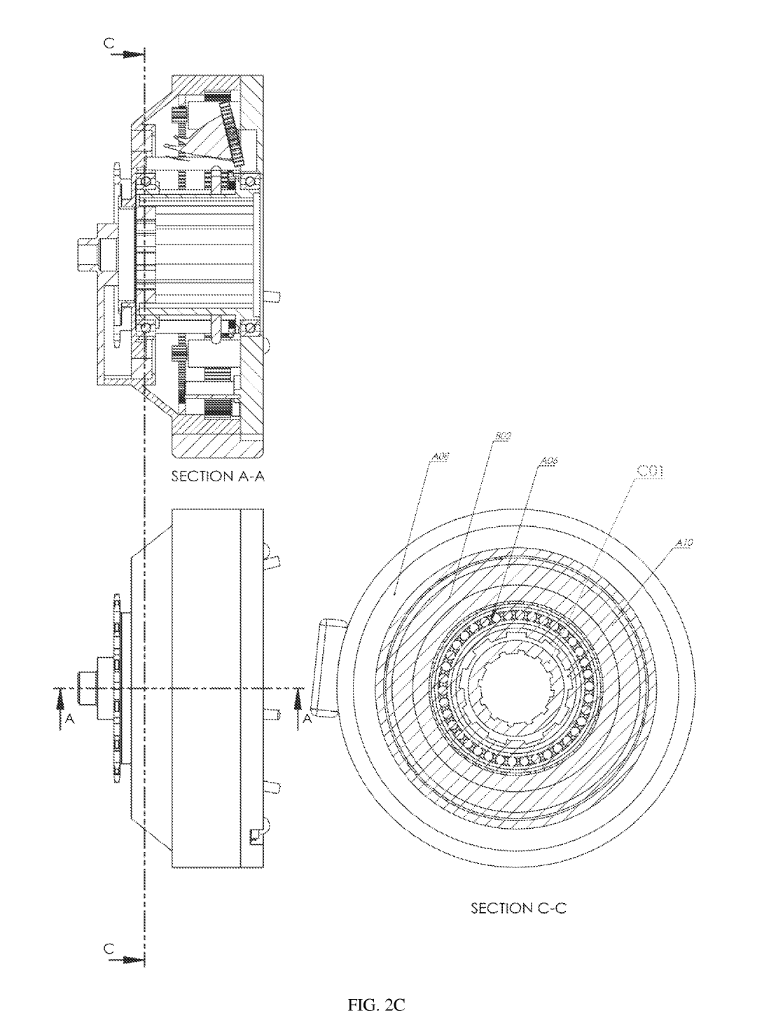

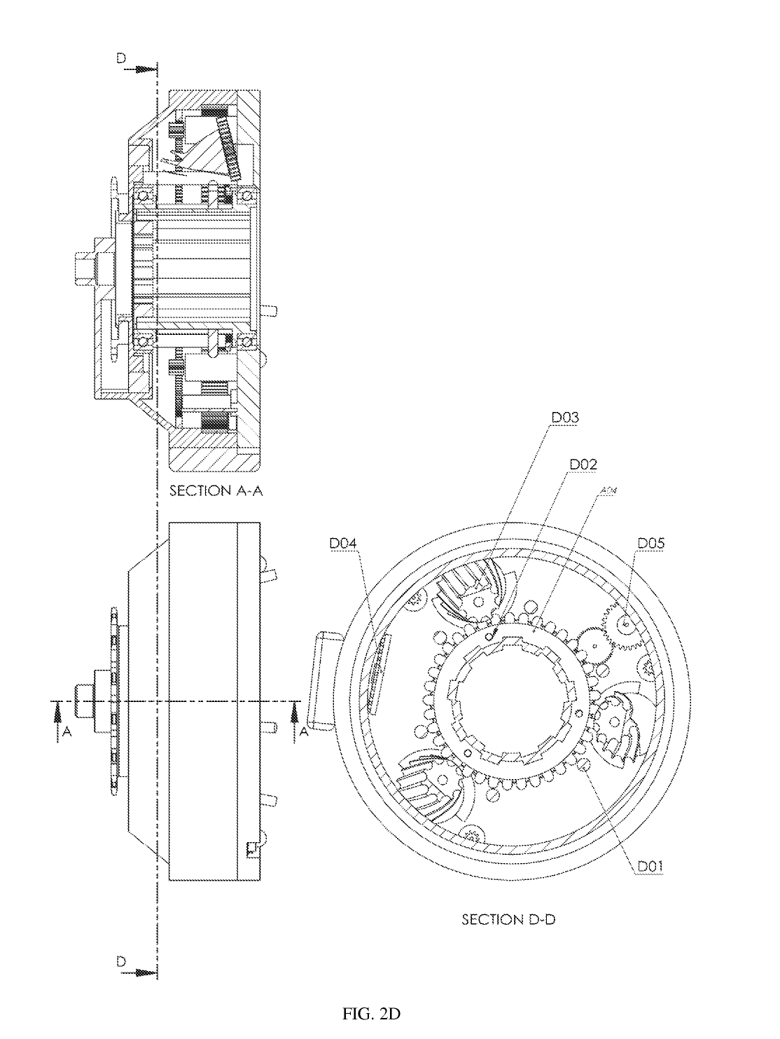

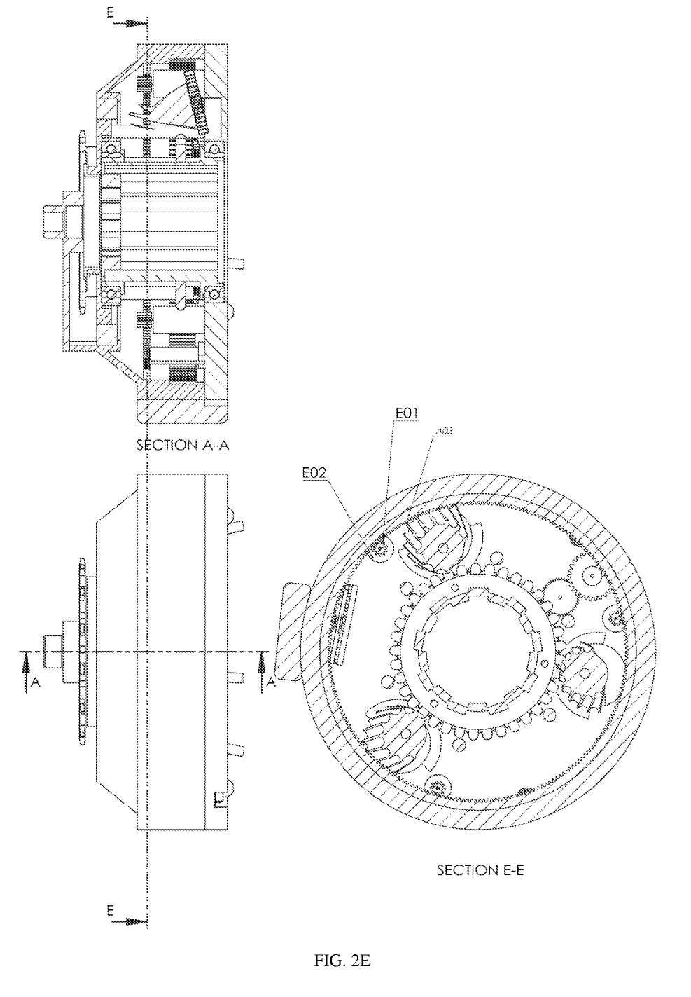

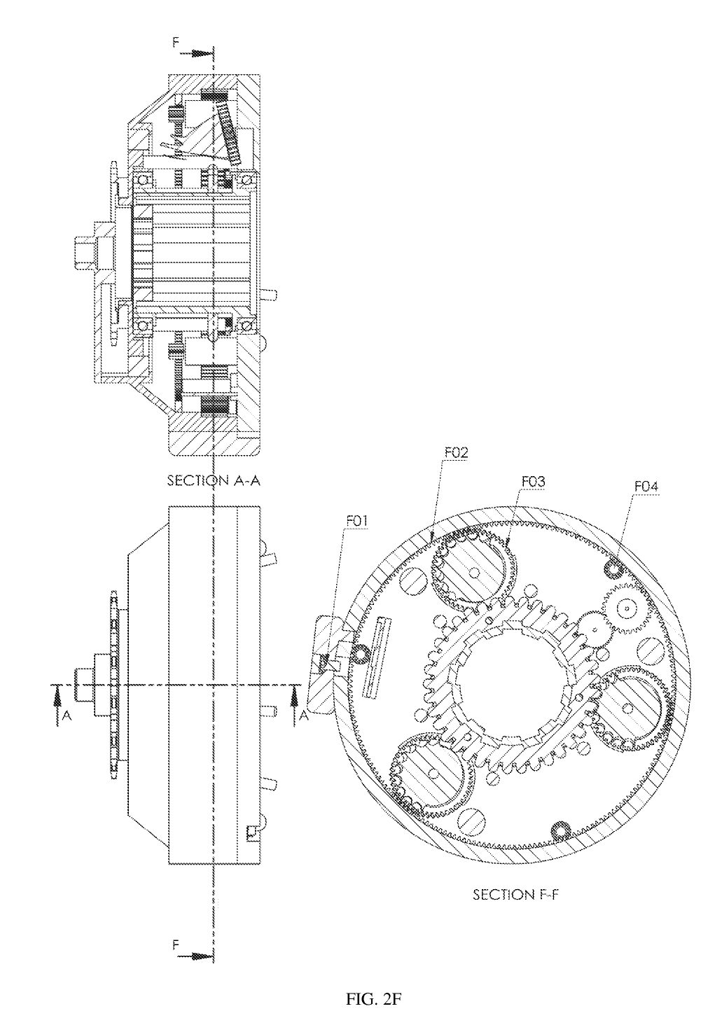

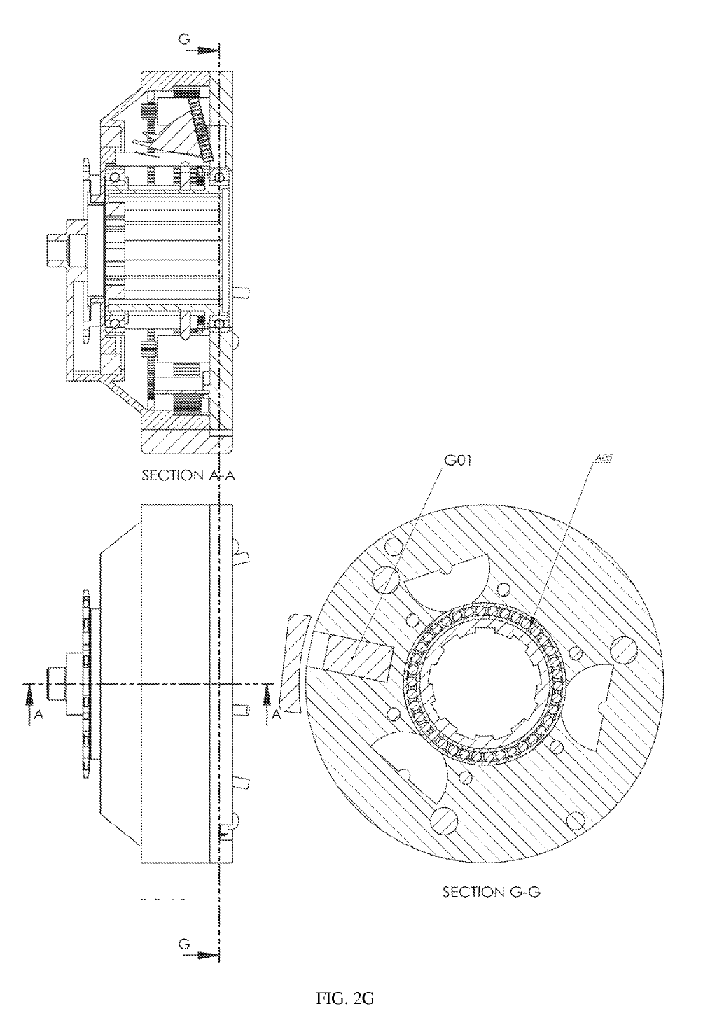

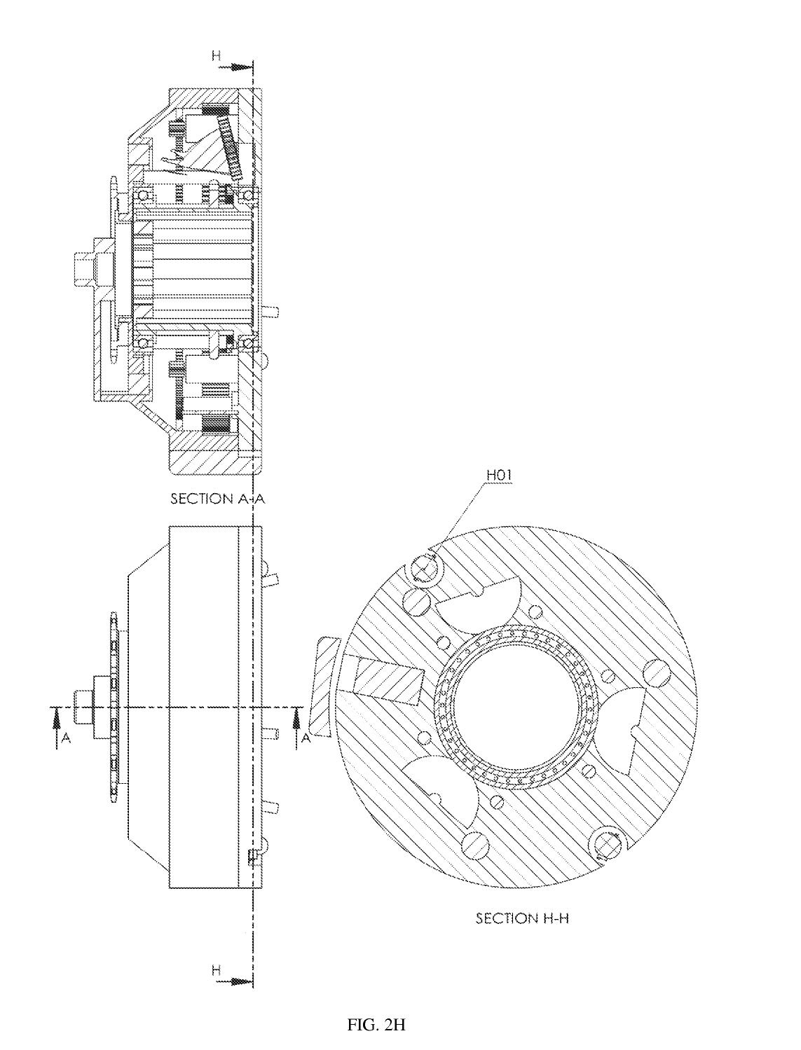

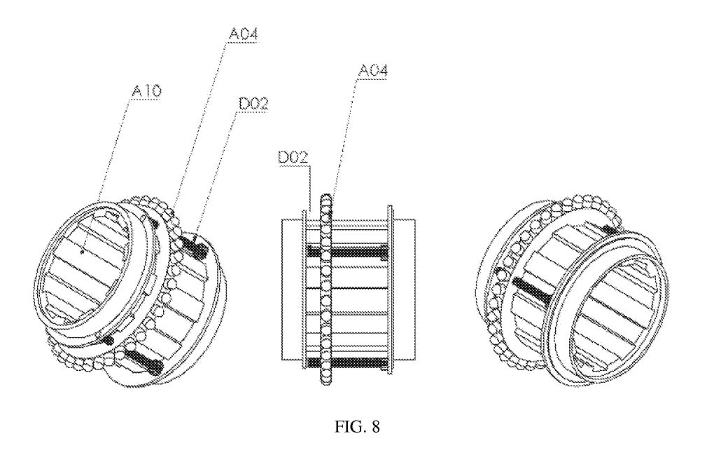

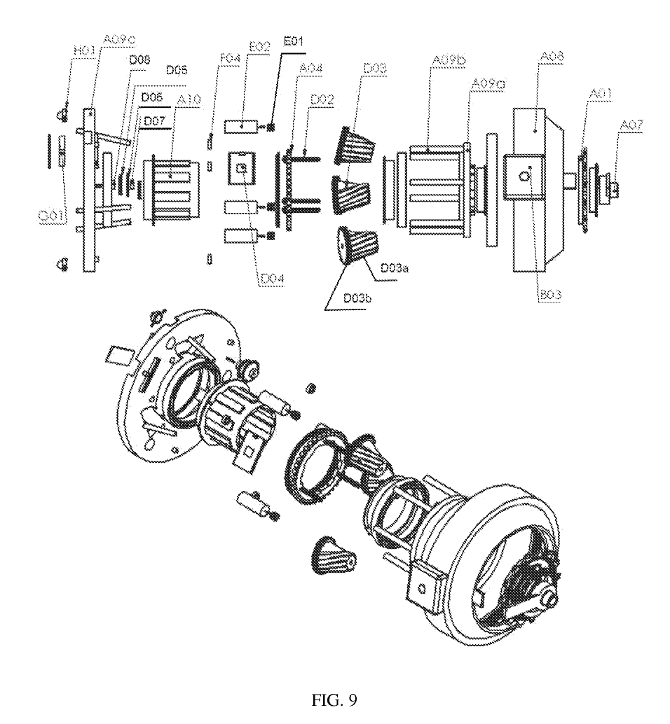

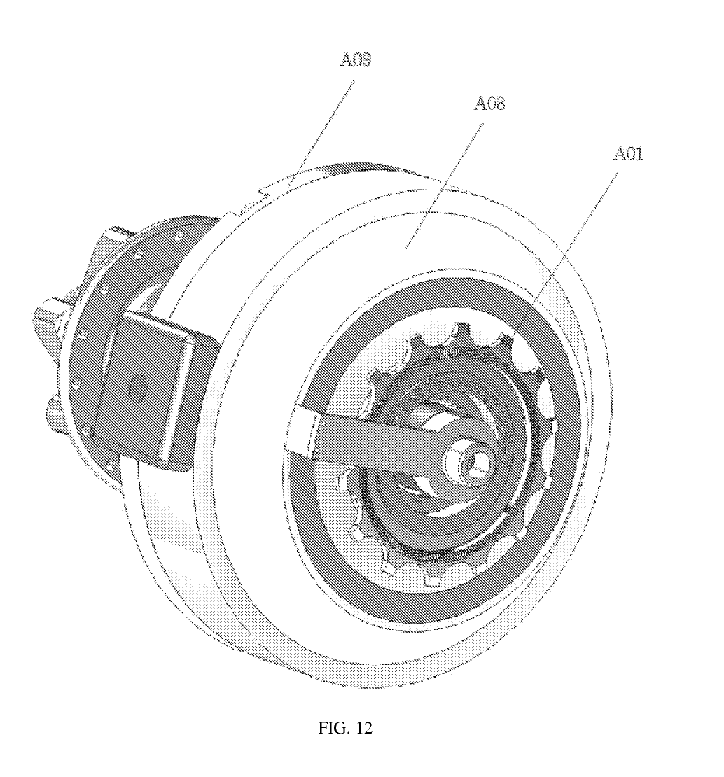

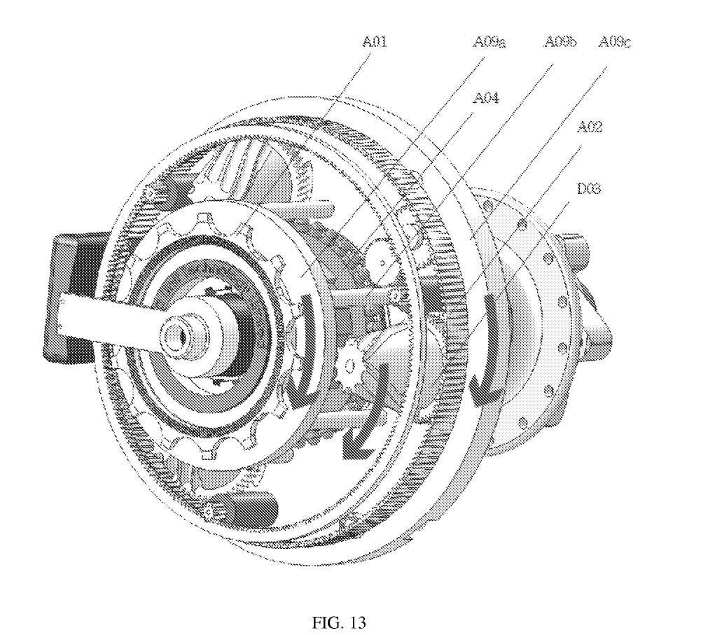

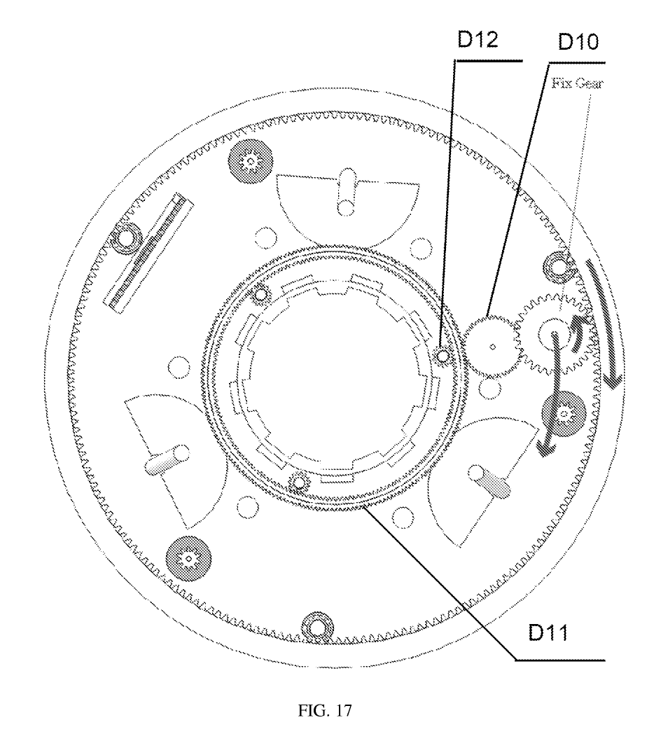

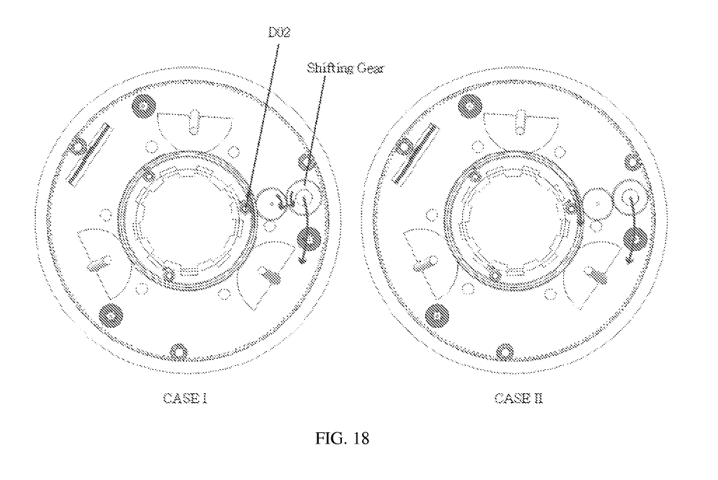

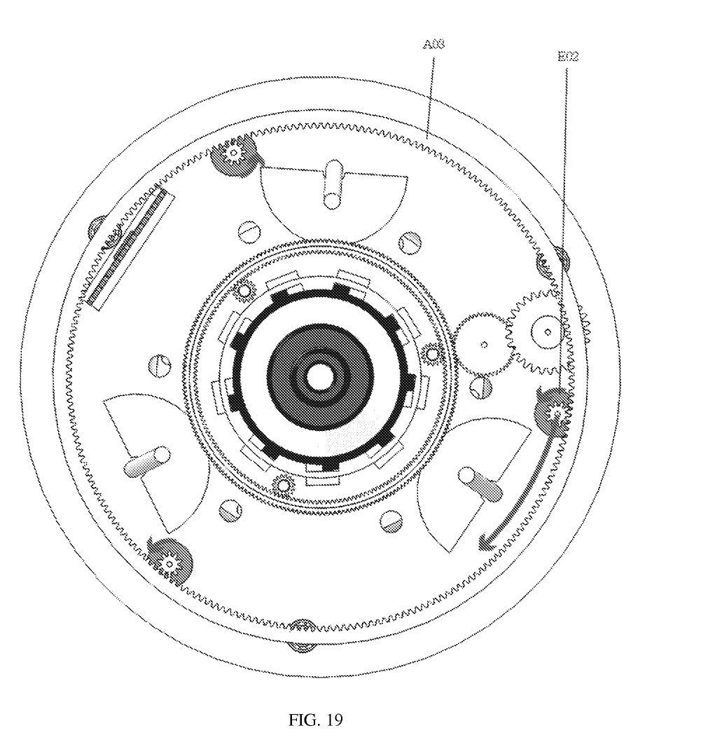

### FIGS. 1-21

FIGS. 1-21 show a first embodiment of the variable transmission gearing system of the present application. As shown in FIGS. 1A-1D, 2A-2H and 9, the variable transmission gearing system may include a mainboard A09 driven by a chain gear A01. Chain Gear A01 can be a driven gear with power transmitted by a bicycle chain. The chain gear can transmit rotational power to the SVT system. It can be attached to a Mainboard “A09” and can drive three Cone Gears “D03” to rotate in a gear box. The number of cone gears may be more or less than three.

Mainboard A09 can be the main driven part. Power from bicycle chain can be directly transmitted to the mainboard. Cone Gears “D03” which are connected to the Mainboard A09 will be rotated simultaneously. Metal Rod D01 can be a connecting part between the outer part and the inner part of the Mainboard “A09”. Bearing B02 can be used to separate the rotation of Mainboard “A09” and Case “A08”.

The three cone gears D03 can be rotatable on three shafts fixed on the mainboard A09 at an angle respectively. Each cone gear D03 may include a ratio gear D03a and a driven gear D03b. The ratio gears D03a may be conical in shape. The driven gears D03b may be formed at the larger ends of the conical ratio gears D03a. The ratio gears D03a may mesh with a central Sun Gear A04. The driven gear D03b may mesh with a first internal spur gear A02 mounted in a gear box.

CONE GEARS “D03” are cone-shaped gears that can be used for transmitting force from bicycle chain to bicycle wheel. Different gear ratios can be obtained by shifting the driven point along the cone surface. Stronger rotational force can be obtained by shifting the driven point to the position where radius is larger while higher speed can be obtained by shifting the driven point to the position where radius is smaller.

Cone Gears D03 can be the main gears in the system. They can provide variable transmission ratio by shifting the contact points between the sloped surfaces of the ratio gears and the Sun Gear “A04”. Ratio gears' teeth formed on the cone gears D03 can be configured to mesh with the teeth of the sun gear A04. Driven Gears' teeth F03 formed on the Cone Gears “D03” can mesh with the teeth of the Internal Spur Gear “A02”.

The sun gear A04 can be rotatable with a hub or an input shaft A10 of a wheel for driving the wheel to rotate. The sun gear A04 can be meshed with the ratio gears of the cone gears D03, and adapted to be shifted in an axle direction along the input shaft A10 by three threaded rods D02. The number of threaded rods may be more or less than three. When the chain gear A01 is rotated anticlockwise, the mainboard A09 and the cone gears D03 rotate anticlockwise and drive the sun gear A04 and the input shaft A10 to rotate clockwise. Bearings A05, A06 can be used to separate rotation of Mainboard “A09” from input shaft “A10”.

Sun Gear A04 may be used to transmit power from Cone Gear “D03” to input shaft “A10”. Sun gear A04 can be shifted along the input shaft “A10” by a Shifting Gear “D05” so that different gear ratios can be obtained.

The input shaft or Hub A10 can be a SVT hub designed to be installed on the bicycle rear hub for transmitting power from the SVT system to the wheel. Sun Gear “A04” can be the driving gear that drives the hub to rotate so that rotational force can be transmitted to the wheel.

The three Threaded Rods D02 can be provided with a position sensor. They can be driven rods formed with threads threadably connected with the Sun Gear “A04”. The driving force from Shifting Gear “D05” can rotate the threaded rods clockwise or anti-clockwise. As the Sun Gear “A04” is connected to the threaded rods, it can shift along the input shaft “A10”. With connection to the MCU, the position of the Sun Gear “A04” can be detected.

The Internal Spur Gear A02 can be attached on an inner surface of a Case “A08” that can be fixed on a bicycle frame. The case A08 can be a cover of the gear box for protecting mechanism running inside. The internal spur gear A02 can be connected to the three Cone Gears “D03” so that reaction force can be developed to drive the Sun Gear “A04” to rotate.

Another Internal Spur Gear A03 can also be attached on the inner surface of the Case “A08”. The internal spur gear A03 can provide reaction force on Gears “E01” so that work can be applied to Motors “E02” to generate electricity. According to the illustrated embodiment, three Spur Gears E01 can be attached on three Generators “E02” respectively. The number of generators may be more or less than three. They can be driven by Internal Spur Gear “A03”. Once Generators “E02” move with Mainboard “A09”, reaction force can be established on the Internal Spur Gear “A03” to rotate Generators “E02”. Therefore electric energy can be generated by them. Electric power generated can be used for charging a 3.7 v Li-Battery placed on battery seat “G01”, lighting up 2 LEDs “H01”, triggering the Shifting Gear “D05” and the Circuit Board. LED Light H01 can be on while mobile phone is connected and bicycle is running at night. It can be switched on or off automatically or manually.

Speedometer B03 is a rotational sensor that can be used for counting rotation speed in rpm. Data may be transmitted to the system's MCU and Mobile in order to calculate the condition of the Sun Gear “A04”. Screw Lock F01 can be used to fix the Speedometer “B03” on the Case “A08”.

Bluetooth 4.0 Controller D04 can be a mini control board built inside the system and equipped with Bluetooth 4.0 connecting functions. Controlling and data transmitting requests can be made by this module to the mobile and the mechanism. By connecting to designed mobile apps, advanced functions can be achieved. Different modes such as “standard”, “comfort”, “race” etc. can be chosen. Running data can be recorded, and reports like distance, slope, and speed can be generated.

Locking Bar Adapter A07 can be used to fix the Case “A08” so that Internal Spur Gears “A02” and “A03” can provide reaction force for Cone Gears “D03” and Gear “E01” respectively. Connector B04 can be used to connect Locking Bar Adapter “A07” to the Case “A08”.

Chain Gear Lock B01 is a tailored screw lock that can be used to fix the Chain Gear “A01” on the Case “A08”. Furthermore, standard Chain Gear Lock C01 can be used for fixing the whole SVT gear box on the rear hub of the bicycle.

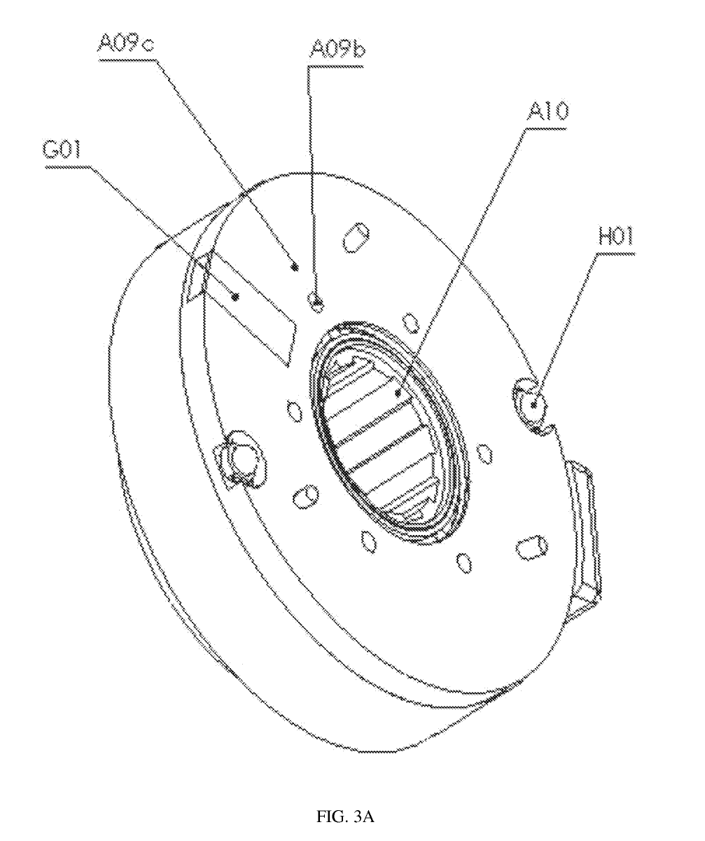

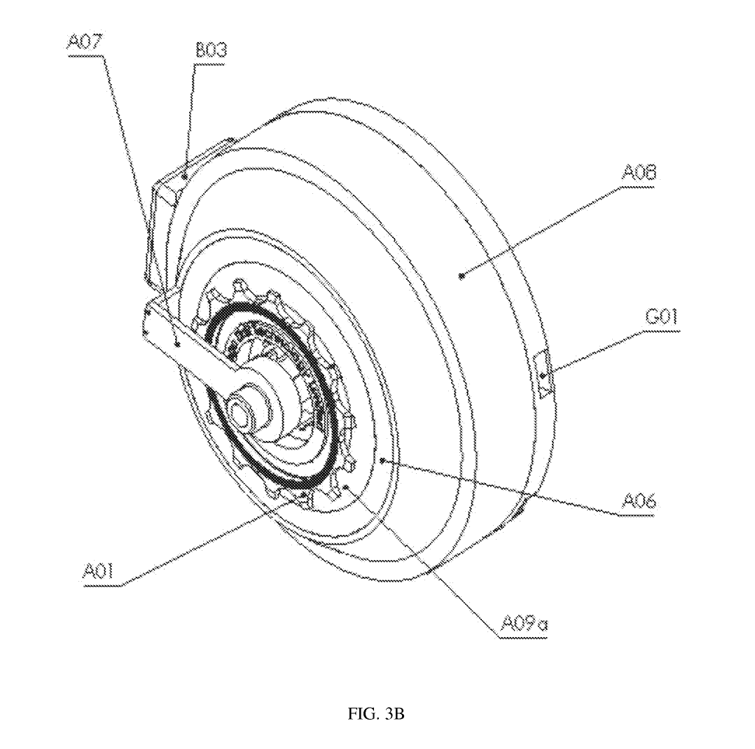

As shown in FIGS. 3A and 3B, the operation of SVT may be mainly divided into three parts, namely HOUSING “A08”, MAINBOARD “A09” and INPUT SHAFT “A10”. They are moving in “driving and driven” relationship by gears provided between them.

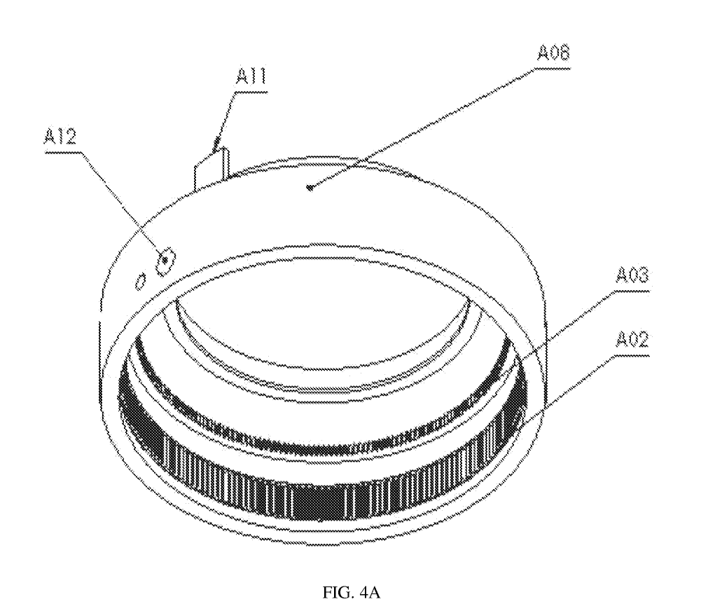

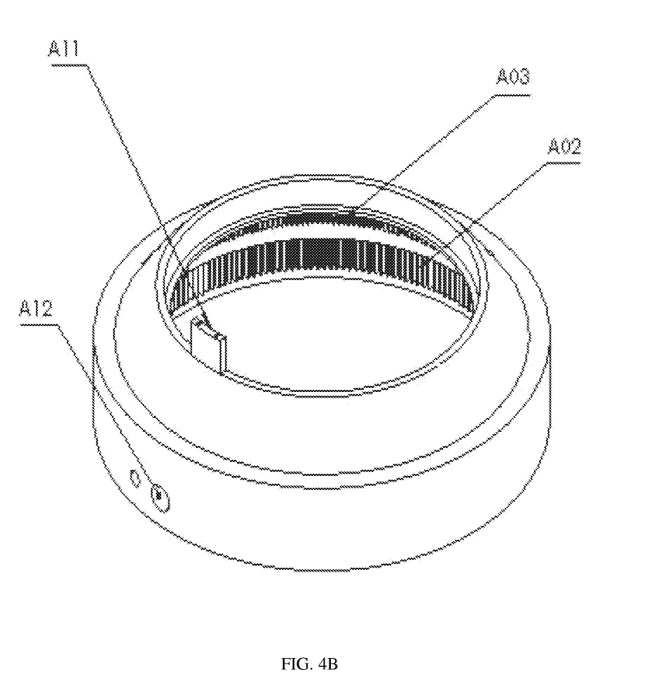

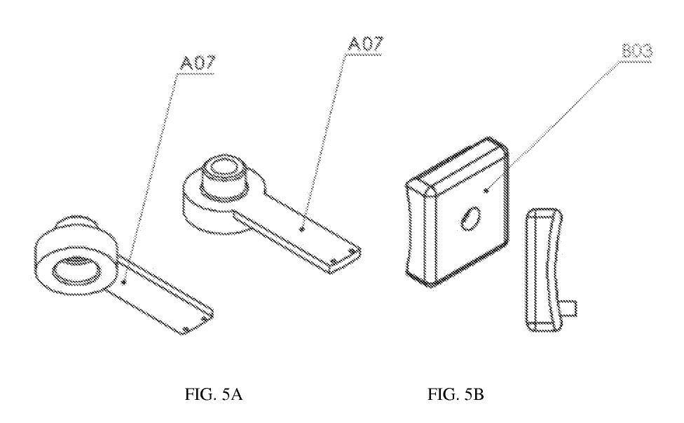

As illustrated in FIGS. 4A, 4B, 5A and 5B, HOUSING “A08” may be a fixed part fixed on the frame by the Locking Bar Adapter “A07” where two INTERNAL SPUR GEARS “A02” and “A03” are attached. CONTROL ARM CONNECTOR “A11” can be an adaptor to which Locking Bar Adapter “A07” may be connected. SPEEDOMETER CONNECTOR “A12” can be an adaptor to which SPEEDOMETER “B03” can be connected.

HOUSING “A08” can be a base for providing reaction force to the mechanism inside so that energy can be transmitted from bicycle chain to bicycle wheel. INTERNAL SPUR GEAR “A02” can provide reaction force for the CONE GEAR “D03” while INTERNAL SPUR GEAR “A03” can provide reaction force for the MINI GENERATOR “E02”.

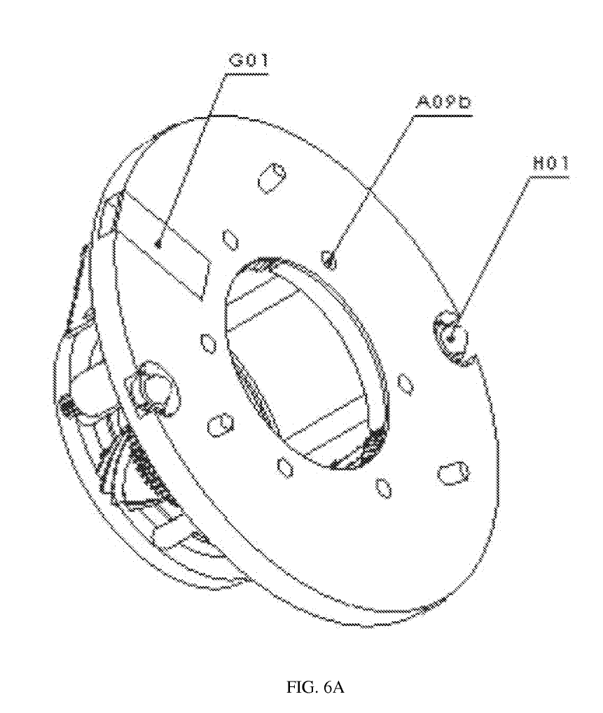

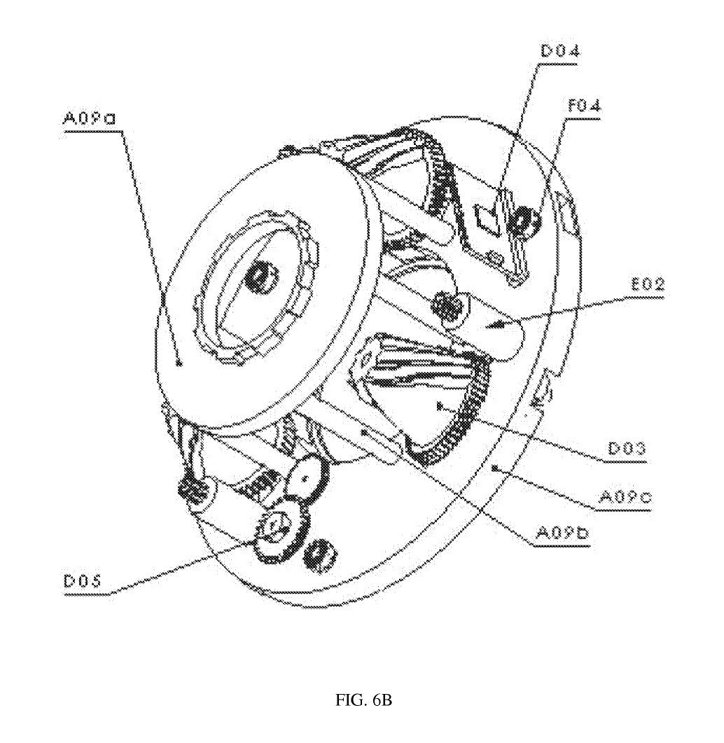

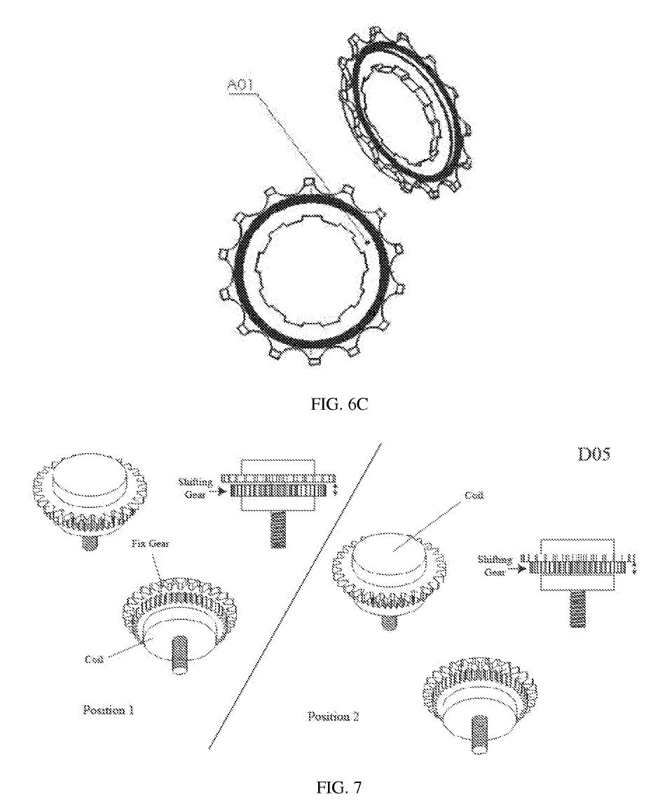

As depicted in FIGS. 6A, 6B and 6C, MAINBOARD “A09” can be the driven part on which SPROCKET GEAR “A01” can be attached. Driving force gained from bicycle chain can be transmitted to that part. Therefore almost all of the mechanisms can be built on it so that gained energy can be used or transformed. Through the built-in mechanism, energy can be converted and transmitted with appropriate gear ratios and drive the input shaft A10 to rotate by three CONE GEARS “D03”.

Built-in mechanism may include CONNECTION RODS “A09b” that can be used to join the CHAIN GEAR SEAT “A09a” and the MAINBOARD “A09c” so that they can rotate together.

BLUETOOTH 4.0 CONTROLLER “D04” and MCU “Machine Control Unit” can control the system operation. Mobile connection and control can be made through that module.

As shown in FIGS. 7-9, a set of magnetic clutch gears can mesh with a set of intermediate gears for driving the threaded rods D02. The magnetic clutch gears may include a shifting gear D05 and a fixed gear D06 sandwiched between upper and lower (first and second) coils D07, D08. The shifting gear D05 and the fixed gear D06 may be rotatable on a pin fixed on the mainboard A09. The lower coil D08 may be fixed on the mainboard A09. The fixed gear D06 may be mounted to a side of the upper coil D07 facing the lower coil D08 and can be meshed with the first internal spur gear A02. The shifting gear D05 may be shiftable along the pin between the fixed gear D06 and the lower coil D08. The set of intermediate gears for driving the threaded rods D02 may include an outer gear D10 meshed with the shifting gear D05, a ring gear D12 having outer teeth meshed with the outer gear D10 and inner teeth meshed with an inner gear D11 fixed on each threaded rod D02.

Abrasive material can be coated on the surfaces of the shifting and fixed gears D05, D06 while they are installed between the two coils D07, D08 which may be separated by springs. Once potential difference applied to the coils, magnetic field developed and the shifting gear D05 can shift. Direction of shifting of the shifting gear depends on which coil potential difference is applied to. The shifting of the shifting gear D05 will drive the Thread Rod “D02” rotate either clockwise or anti-clockwise, and therefore control the Sun Gear “A04” shifting along the input shaft “A10”.

Once current passes through the coil, magnetic field is formed and attracts the “Shifting Gear”. Therefore current passes through the upper coil will pull the “Shifting Gear” upwards, while current passes through the lower coil will pull the “Shifting Gear” downwards. The abrasive surface of the “Shifting Gear” can provide frictional force between itself and the gear to be mated. Therefore the “Shifting Gear” will be driven and rotated in same direction according to the gear which is mated.

When the shifting gear D05 is paired with the fixed gear D06, the shifting gear D05 rotates anticlockwise and drives the threaded rods D02 to rotate anticlockwise so that the sun gear A04 moves towards the mainboard A09, and when the shifting gear D05 is paired with the lower coil D08, the threaded rods D02 rotate clockwise, and the sun gear A04 moves away from the mainboard A09.

MINI-GENERATORS “E02” are mini generators that can generate electric power while rotational force is transmitted. The electric energy will be mainly used to support the electronic parts and the generation of magnetic field. The remaining energy will be stored into a battery. Battery “G01” can be used for providing stable electric energy for the electronic parts of the system.

BEARING “F04” is a separator for preventing friction effect from the rotation of MAINBOARD “A09” and the HOUSING “A08”. LEDs “H01” will be lit while the SVT system connected to the mobile phone at night. User can switch them off through the mobile app.

INPUT SHAFT “A10” can be a driven part of the SVT system. It drives the wheel hub to rotate directly. The SUN GEAR “A04” can be a transmission gear. Rotational force from the CONE GEAR “D03” can be transmitted to the INPUT SHAFT “A10” through the SUN GEAR A04. SUN GEAR “A04” will be shifting along the INPUT SHAFT “A10” so that different contact point (gear ratio) on the CONE GEAR “A04” can be used. Shifting the SUN GEAR “A04”, three THREAD RODs “D02” may be used. Those rods can be driven by a set of gears that connected to the MAGNETIC CLUTCH GEAR. Once the THREAD RODS “D02” are driven to rotate clockwise, the SUN GEAR “A04” will be shifted forward while shifted backward while the THREAD RODS “D02” are rotating anticlockwise.

Once the SVT gearing system has been installed, it can be used either with mobile connection or not. With mobile app connected, advanced functions of the SVT gearing system can be used.

### Without Mobile App

SVT is mainly controlled by a program set on the built-in MCU. SVT is an infinite gears transmission system. The number of gear ratio it can be equipped with depends on the program set on the MCU. Without mobile connected, the system can be equipped with 6 intervals of gear ratios between 0-1, i.e. 0, 0.2, 0.4, 0.6, 0.8, 1 of the position of the SUN GEAR “A04”. Position “0” of the SUN GEAR “A04” is the gear ratio that less force is required but lower speed is resulted while position “1” is the gear ratio that stronger force is required but higher speed is resulted.

### With Mobile App

With mobile connected, higher and advanced performance of the SVT can be used as the mobile is powerful nowadays. With smart phone connected, it will take over the role of MCU (Machine Control Unit). With smart element involved, the SVT can function in a much humanity way. For example, this may include number of gear ratio interval to be set, gear changing habit, real time human understandable response shown on the mobile screen, and data sharing through the internet etc.

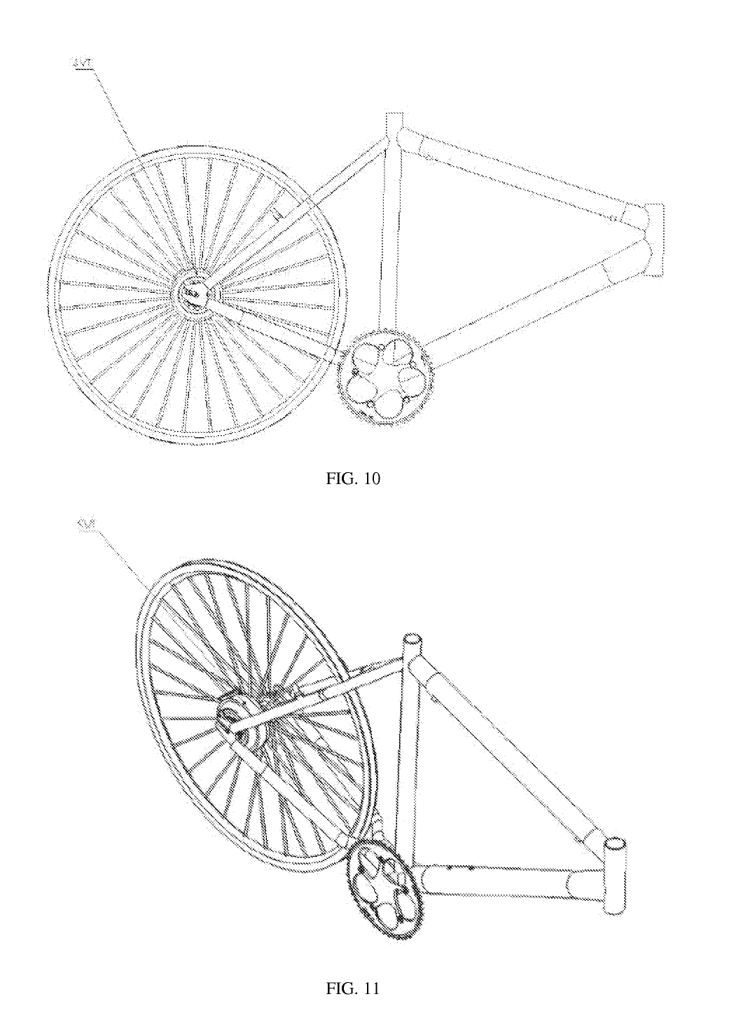

FIGS. 10-19 show the operation of the SVT system starting with the driven CHAIN GEAR “A01”.

As illustrated in FIGS. 10-13, the SVT system is designed with the concept of “PLUG and PLAY” that is easy to be installed at the same position as the traditional gear box. No extra modification is required. Once SVT has been installed, driving force can be gained through the chain and the CHAIN GEAR “A01” that is provided on the SVT. The CHAIN GEAR “A01” can be mounted on the CHAIN GEAR SEAT “A09a” and the rotational power directly drives the MAINBOARD “A09C” to rotate simultaneously.

While the MAINBOARD “A09” rotates, mechanisms built on it rotate simultaneously. As the shafts of the CONE GEARS “D03” are attached on the MAINBOARD “A09”, they rotate with the mainboard and cause the CONE GEARS “D03” to move circularly following the MAINBOARD “A09”.

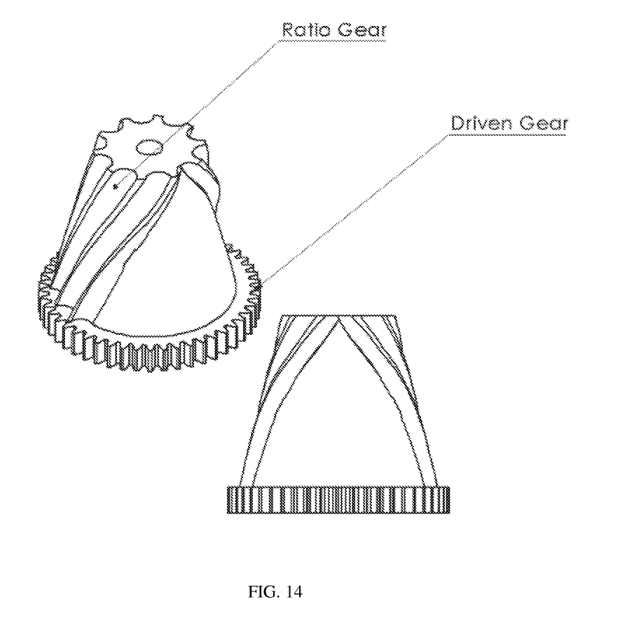

As depicted in FIG. 14, each CONE GEAR “D03” is divided into two parts, one is the driven gear that gain a reaction force from the INTERNAL SPUR GEAR “A02” which is fixed on the HOUSING “A08”. The other is the ratio gear that has a cone-shaped surface.

Once the CONE GEARS “D03” move with the MAINBOARD “A09” in a circle, action-reaction forces act on the INTERNAL SPUR GEAR “A02” from the driven gear part, rotational force (in anti-clockwise direction) acts on the CONE GEAR “D03”, and therefore the CONE GEARS “D03” rotate.

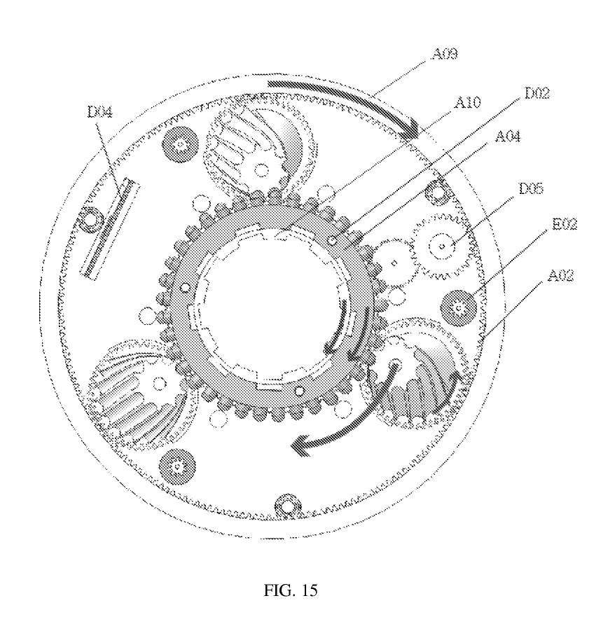

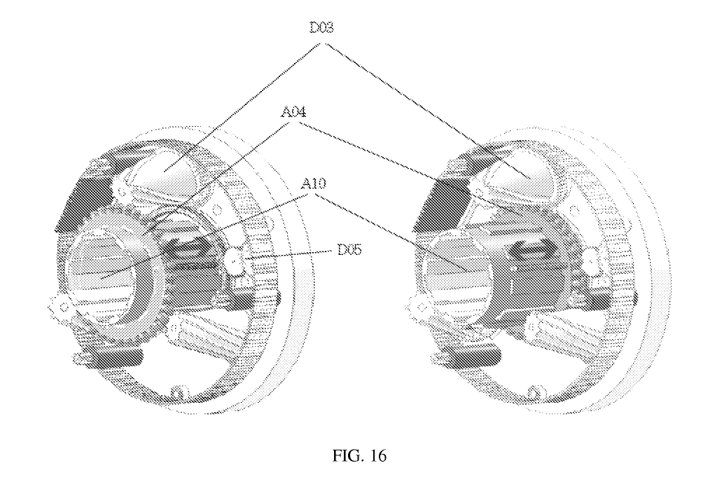

As illustrated in FIG. 15, while CONE GEARS “D03” rotate in anti-clockwise direction, the ratio gear parts drive the SUN GEAR “A04” to rotate in opposite direction. The rotational force gained by the SUN GEAR “A04” will be transmitted to the INPUT SHAFT “A10” directly. Therefore rotational force can be transmitted to the bicycle chain from the wheel.

By using CONE GEARS “D03”, infinite gear ratio can be used by shifting the position of SUN GEAR “A04”. Shifting the position of the SUN GEAR “A04”, different contact points to the Ratio Gear parts of the CONE GEARS “D03” can be used. By shifting the contact points to the position the CONE GEAR with a larger diameter, less force is required but lower speed resulted, while small diameter provides higher speed but required more force.

As shown in FIGS. 16-19, a set of gears can be used to shift the SUN GEAR “A04” along the INPUT SHAFT “A10”. The set of MAGNETIC CLUTCH GEARS is a main controller of the shifting motion. It's a clutch system that controlled by the MCU. A programmed MCU controls the electric current passing through the coils of the MAGNETIC CLUTCH GEARS so that the Shifting Gear D05 of the MAGNETIC CLUTCH GEARS paired with the Fix Gear or the Lower Coil.

Case I: Pairing with the Fix Gear D06, the Shifting Gear D05 will be driven to rotate in the same direction as the Fix Gear. Since the Fix Gear is connected to the INTERNAL SPUR GEAR “A02” and the shaft built on the MAINBOARD “A09c”, when the MAINBOARD “A09C” is rotating, the Shifting Gear will move simultaneously. The INTERNAL SPUR GEAR “A02” provides reaction force to the Fix Gear and makes it rotating in anti-clockwise direction. As the Shifting Gear is attached on it, the Shifting Gear rotates in anti-clockwise direction too. After a series of gear set, it drives the THREAD RODS “D02” to rotate in anti-clockwise direction. Therefore, the SUN GEAR “A04” moves towards the MAINBOARD “A09c”.

Case II: By paring to the Lower Coil D08, as the Lower Coil is fixed on the MAINBOARD “A09c” without any rotation, therefore once the Shifting Coil D05 attached on it, the Shifting Coil will cease to rotate and cause the THREAD RODS “D02” to rotate in clockwise direction. Therefore the SUN GEAR “A04” moves away from the MAINBOARD “A09c”.

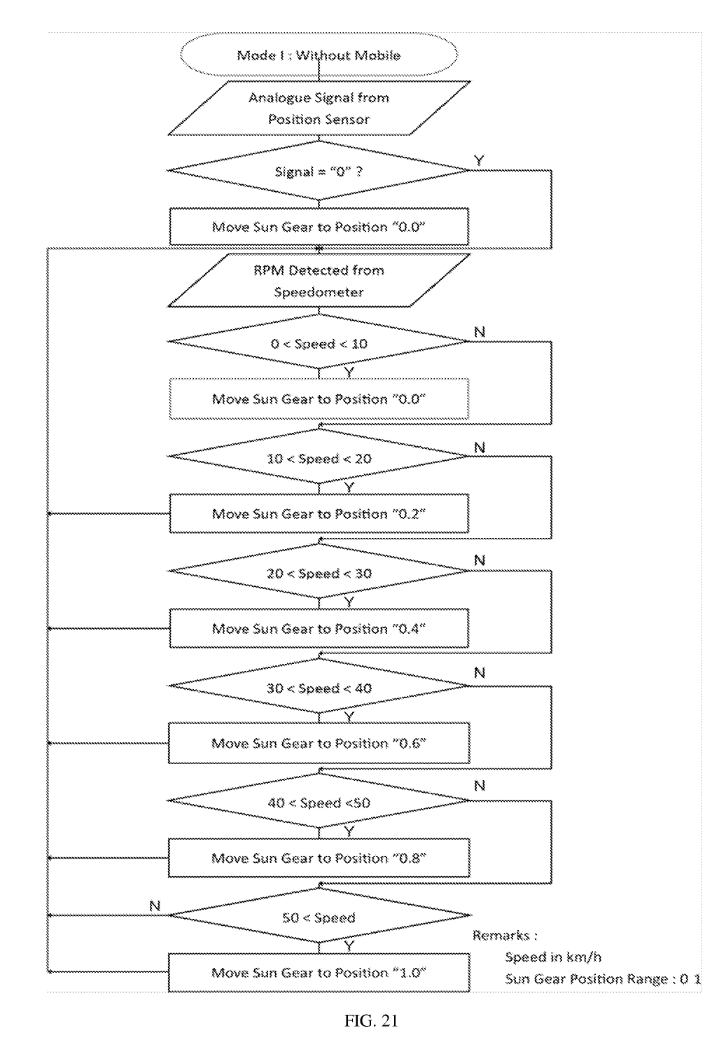

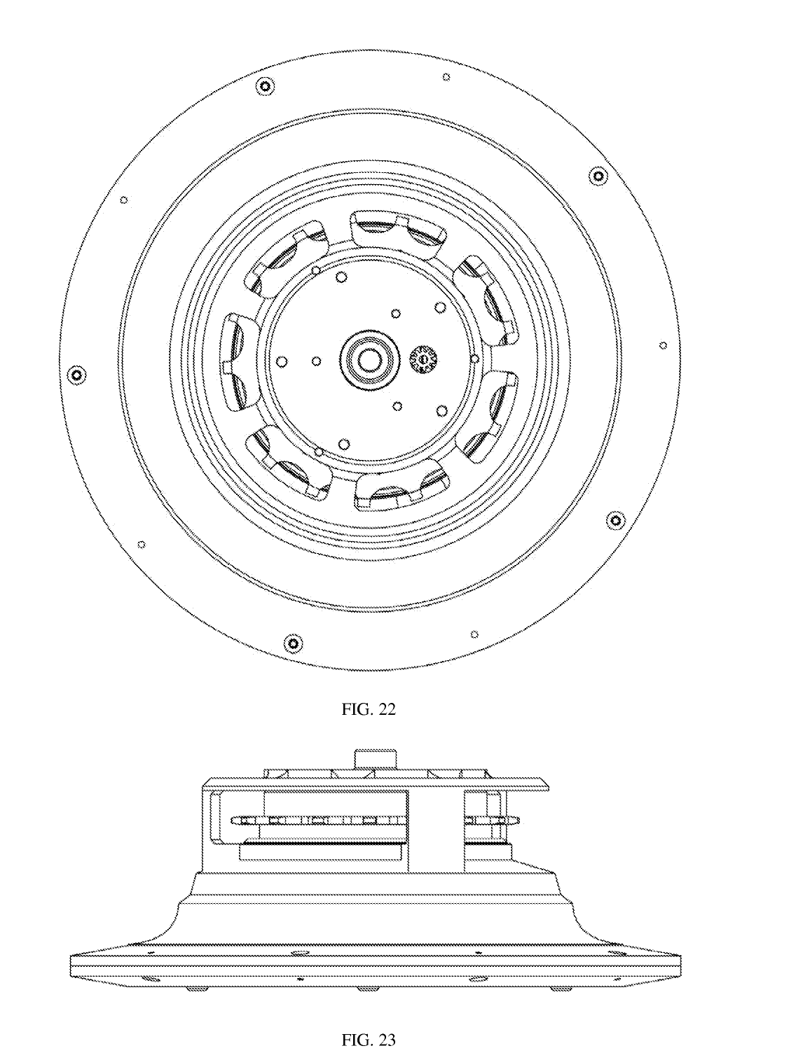

Controlling Process without Smart Phone Connection (Flow Chart in FIG. 21)

The part to be controlled is the position shifting of the SUN GEAR “A04”. Shifting the position of the SUN GEAR “A04”, a programmed MCU built-in on the system controls the signal sent to the MAGNETIC CLUTCH GEARS so that the THREAD RODS “D02” rotate accordingly.

Before control signals are sent to the MAGNETIC CLUTCH GEARS, speed data would have been collected through the SPEEDOMETER “B03”. According to the program set on the MCU, relevant signal will be sent to the MAGNETIC CLUTCH GEARS for the controlling.

As shown in the flow chart, “0-1” is the interval reference of the position of the SUN GEAR “A04”. “0” represents the lowest gear ratio while “1” represents the highest gear ratio. Lower gear ratio provides slower rotation speed output but less force is required while higher gear ratio provides higher rotation speed output but stronger force is required.

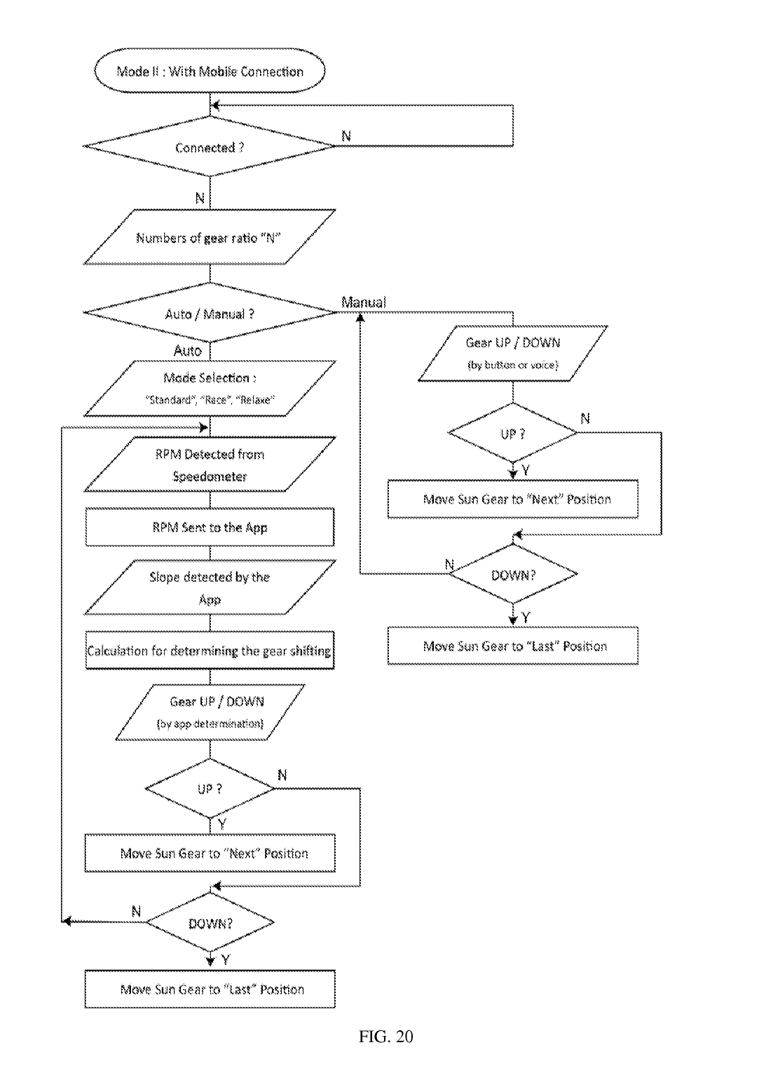

Controlling Process with Smart Phone Connection (Flow Chart in FIG. 20)

With Smart Phone connected, advanced functions and performance of the SVT can be used. As the moving habit of the SUN GEAR “A04” is directly responding to the riding performance such as speed, force, efficiency and suitability and so on. Therefore, the more variation of the habit the SVT is equipped with, the more powerful it can perform. Smart phones nowadays are much powerful than before, it is similar to a mini computer that can handle great deal of data processing. Using a smart phone connected to the SVT, it will take over the role of MCU. By designing an app for controlling the SVT, much more running processes can be handled, and therefore SVT can function in a humanity way and can become more interactive.

Humanity or so called “Smart” depends on the program designed for the app. The basic function of the app is similar to the program set on the MCU by controlling the signal sent to the MAGNETIC CLUTCH GEARS. But the program will be much more complicated by analyzing a large amount of data collected and adjusting the position of the SUN GEAR “A04” more precisely.

Data such as speed, slope and the position of the SUN GEAR “A04” will be collected by relevant sensors. Analyzing of those data is a real time process based on the criteria preset by users. Since it's a variable transmission gear box, criteria such as numbers of interval of the gear ratio, gears changing habit can be customized by users. The program designed will calculate by equations with those collected data and customized variables to determinate the time for shifting the SUN GEAR “A04” to an appropriate position along the INPUT SHAFT “A10”. Therefore different gear ratios can be used.

With the smart phone connected, not only automatic transmission can be used, manual transmission can also be selected if users prefer to use. For the manual mode, users can change gear ratios through the app interface. Through the app interface, there are several buttons provided for shifting gear ratios such as “UP”, “DOWN”. Once a button is triggered, the app sends a signal to the MCU built-in on the SVT to shift the position of the SUN GEAR “A04”.

For providing a wide range of gear changing method, voice recognition function can be provided. By using voice recognition, users speak to the microphone with designated commands, for example “GEAR UP”, “GEAR DOWN”. Hence, shifting command can be triggered by voice. No physical touching is needed for riders.

By notifying users about the status of the bike or the gear box, various views can be designed in the apps. Users can select the information they are interested and display on the mobile during bicycle riding. Information such as speed, slope, location, gear ratio, riding path, distance etc. can be selected.

As the system is equipped with lights, once the smart phone is connected, it lights up automatically at night for safety. Users can switch those lights on or off through the app.

Since smart phone can be connected to the internet, users can share their riding data to a cloud server. With data collected in real time, the SVT can be controlled or followed by server. For racing games or group games, their performance can be reported or recorded down anytime with relevant login.

### Second Embodiment

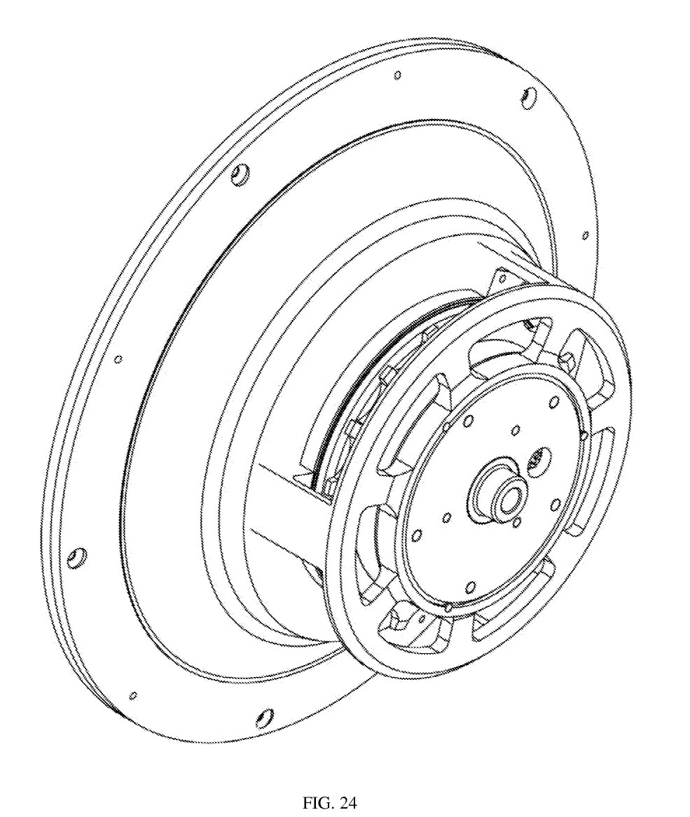

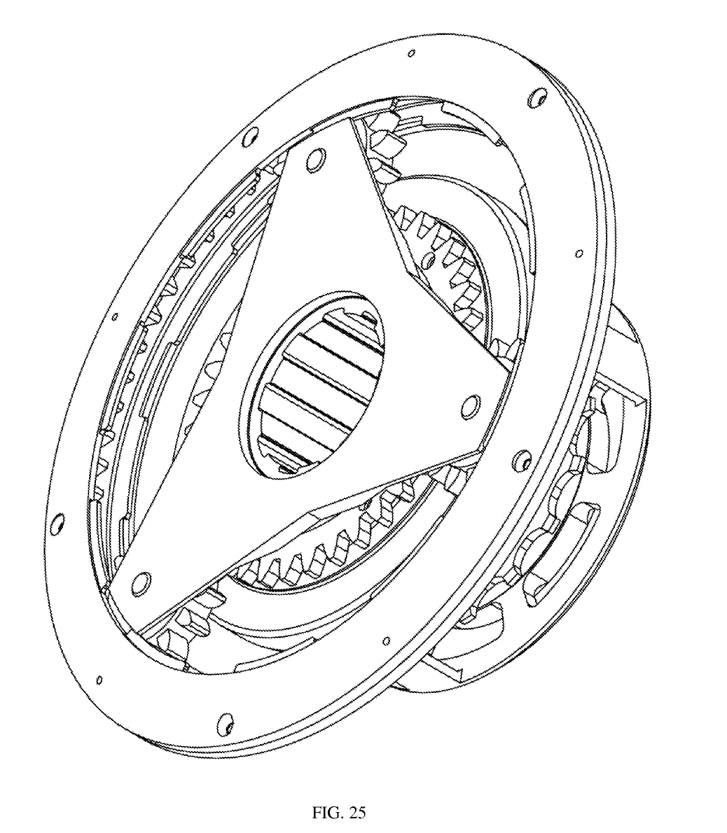

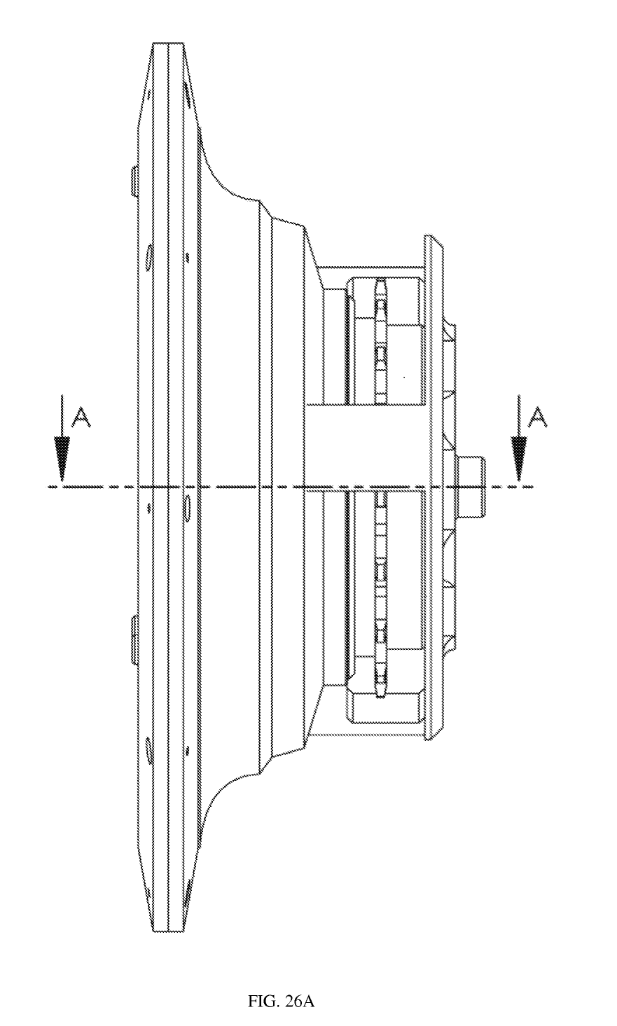

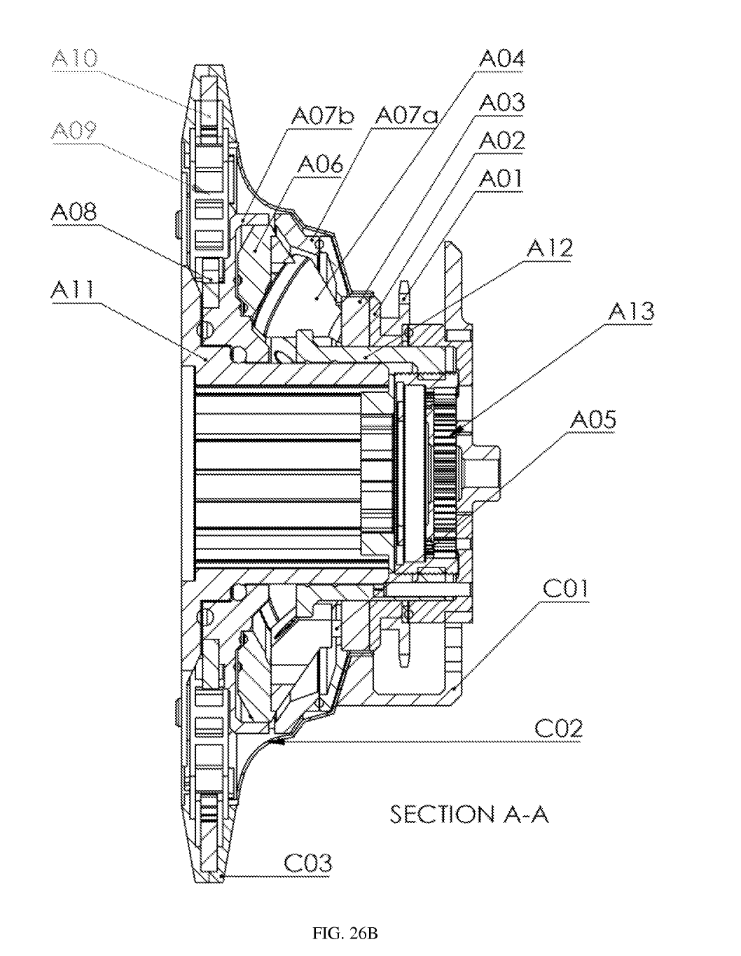

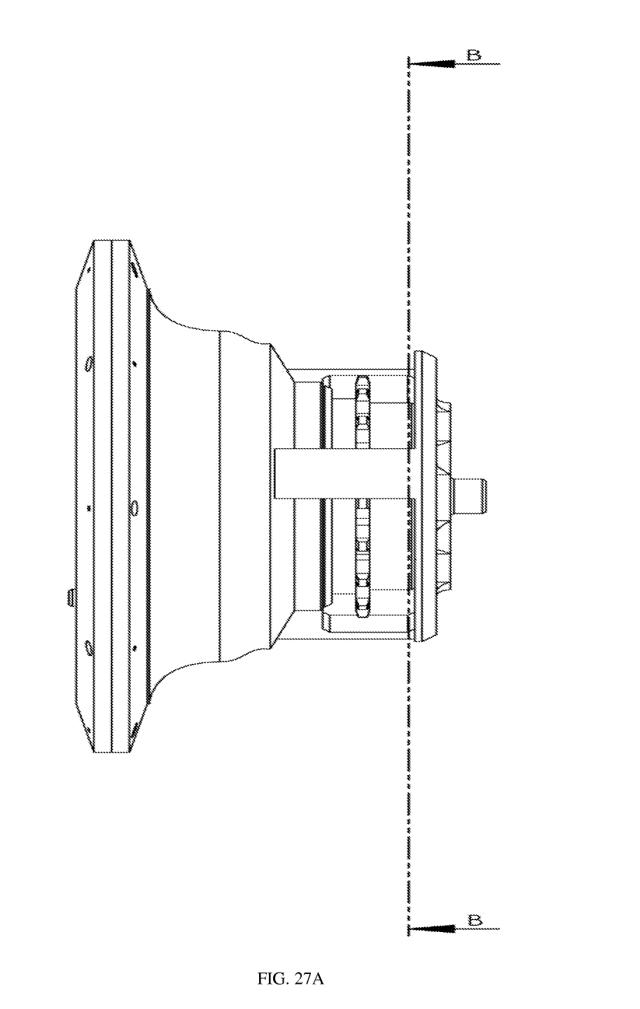

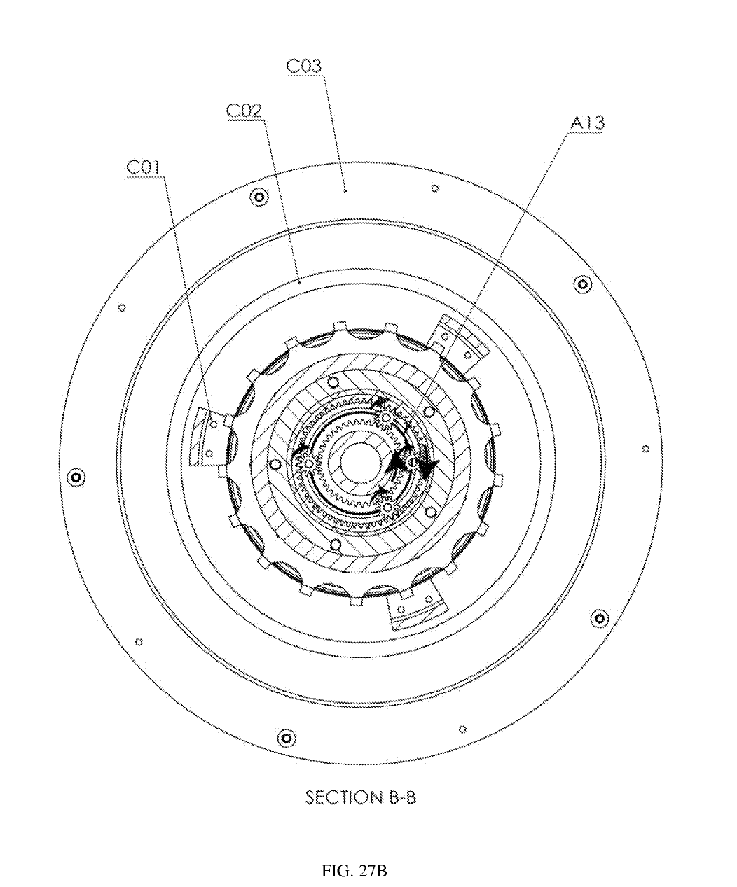

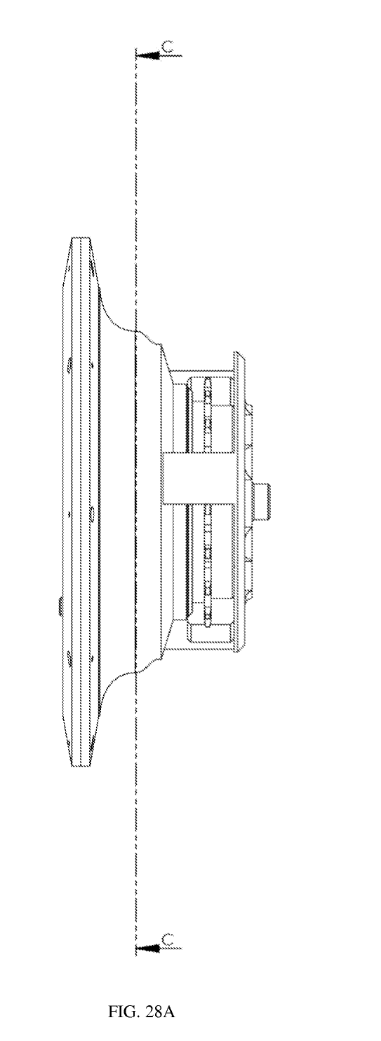

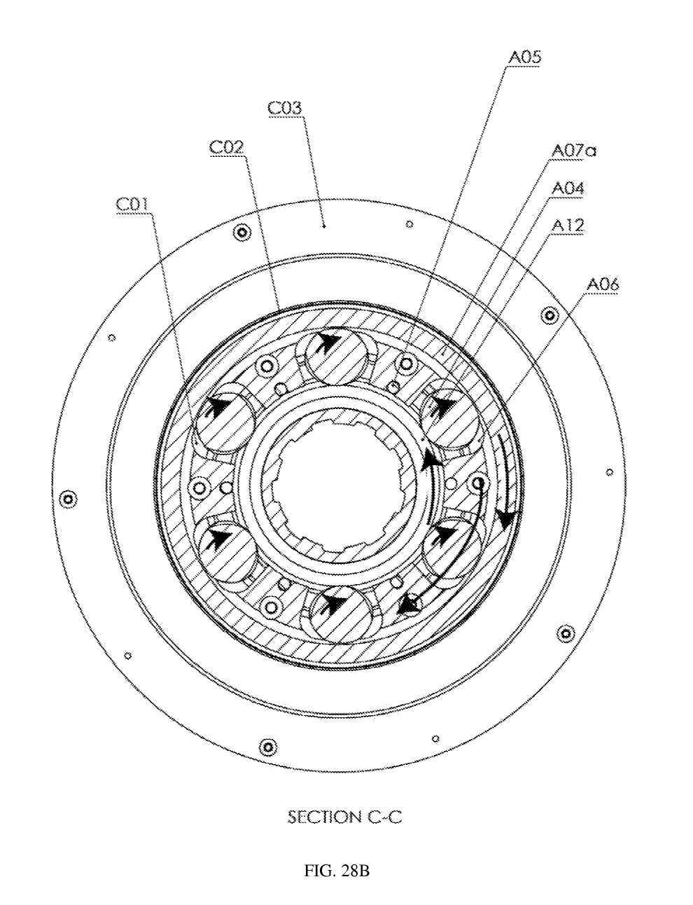

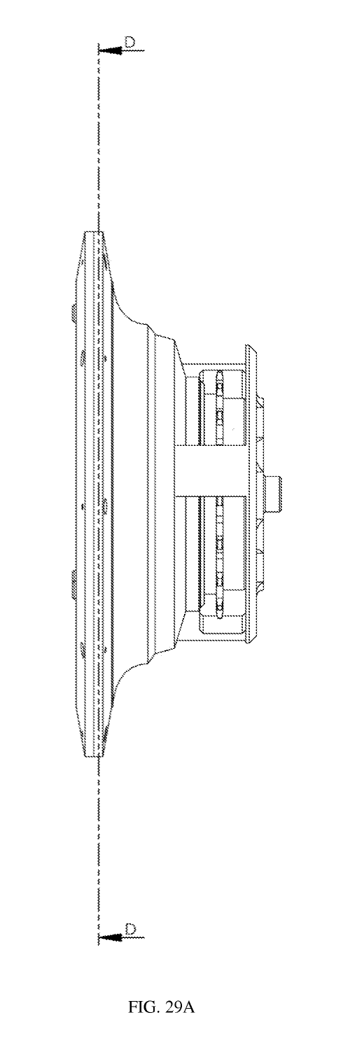

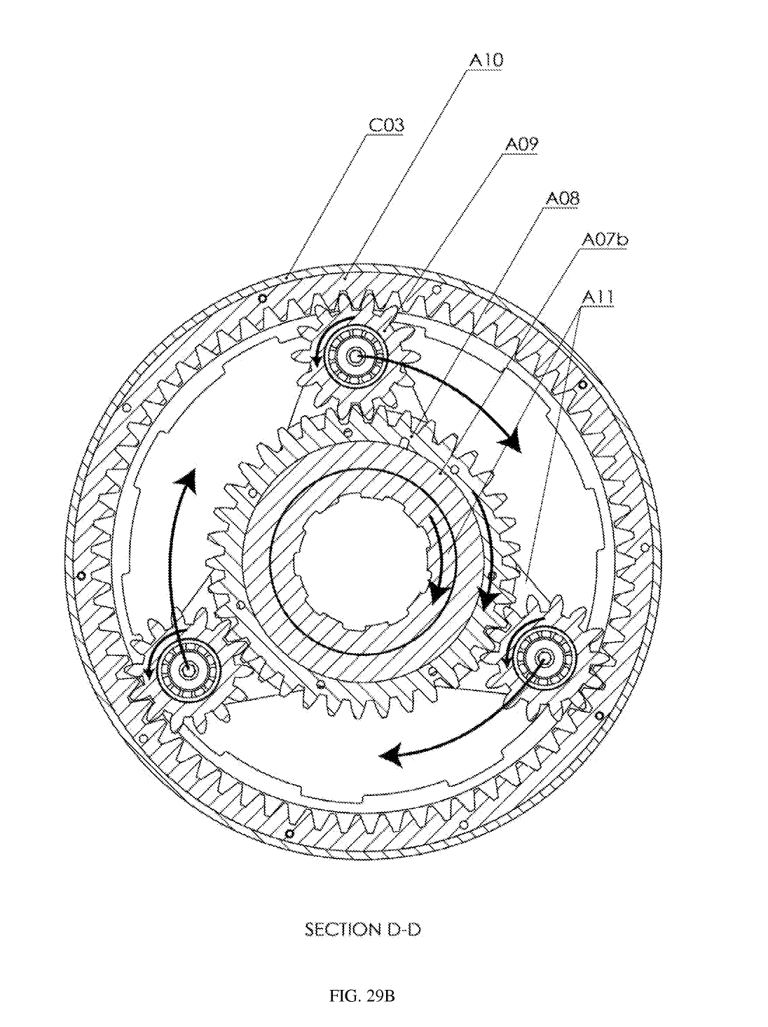

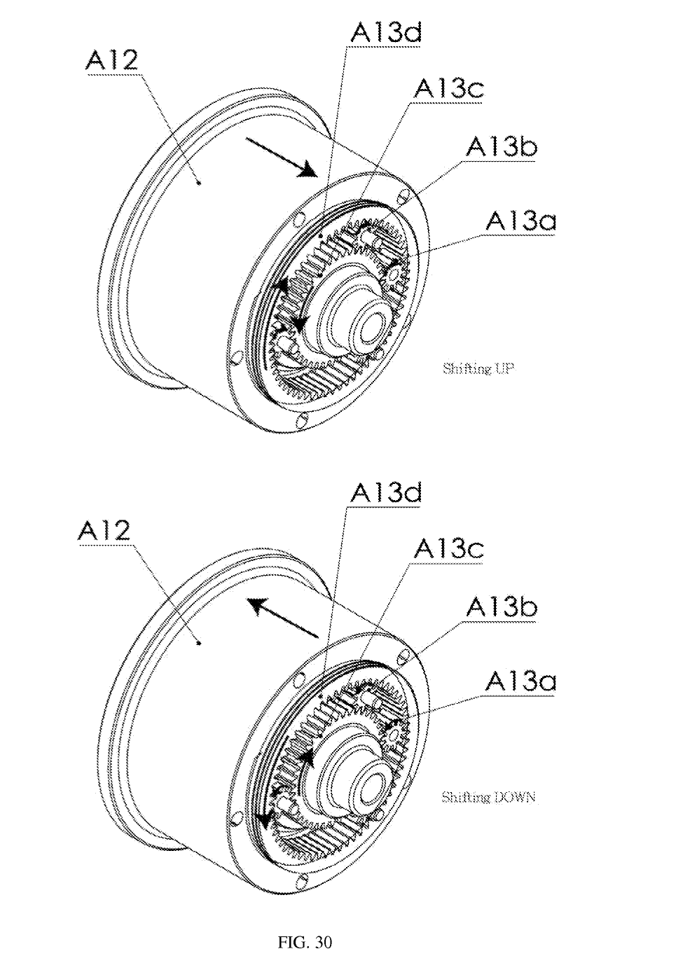

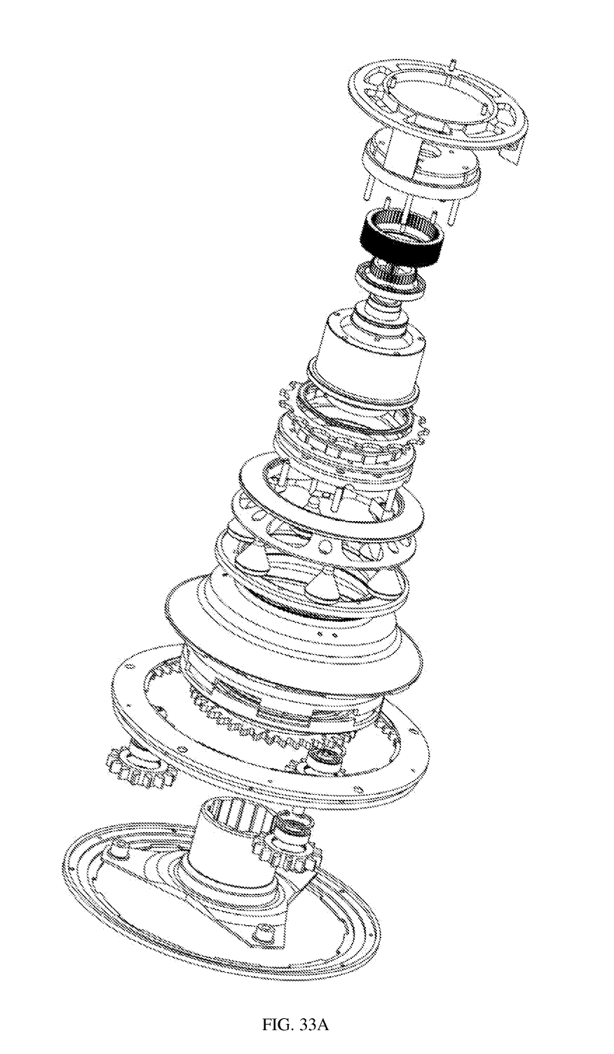

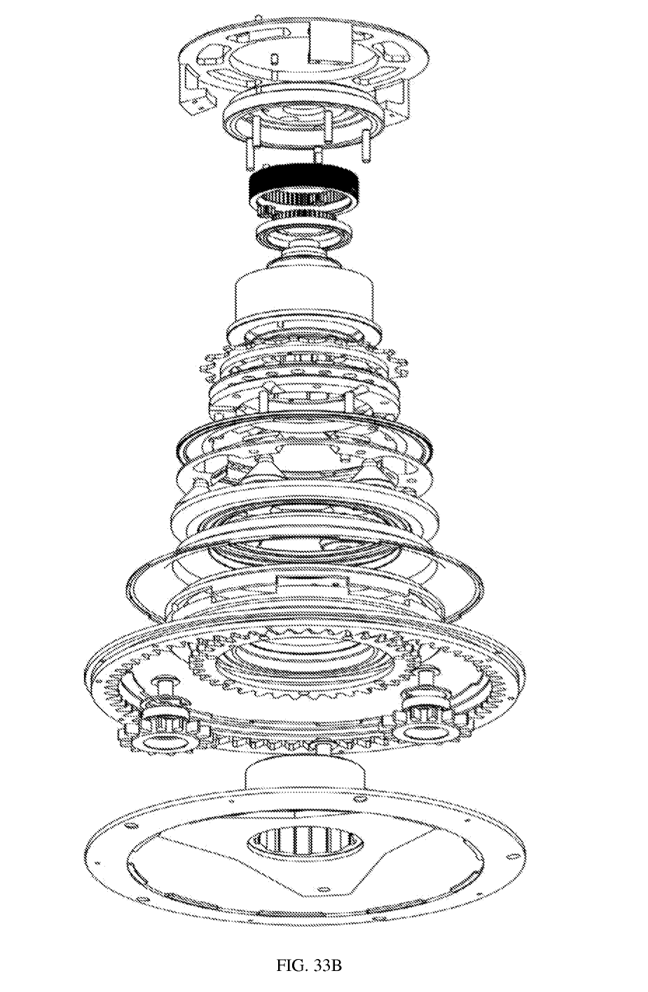

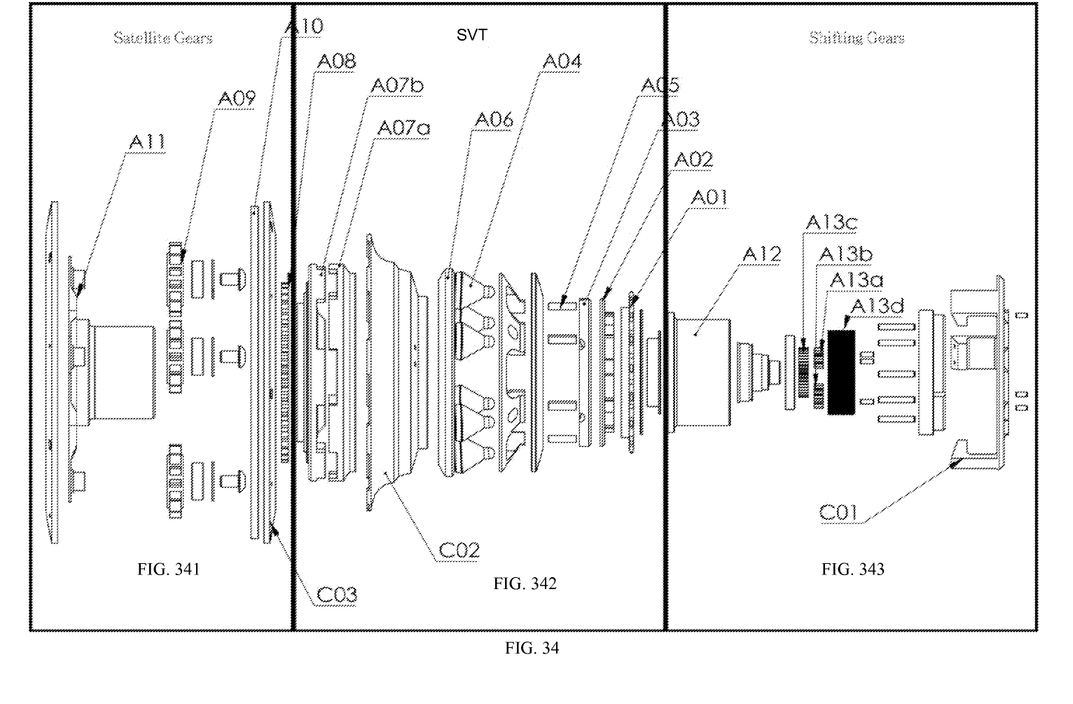

### FIGS. 22-36

FIGS. 22-36 show a second embodiment of the variable transmission gearing system of the present application. As shown in FIGS. 22-29, 33a, 33b and 34, the variable transmission gearing system may include a sprocket A01 mounted on a sprocket mount A02. Sprocket A01 can be a gear driven by power transmitted from a user's leg through a bicycle chain or belt. The sprocket A01 can be attached to the mount “A02” for receiving and transmitting power to the SVT system. The sprocket mount may be annular and formed with a plurality of openings. A cone driver A03 may be coupled with the sprocket mount A02 by a plurality of balls provided thereinbetween. The cone driver A03 can be rotatable with the sprocket mount A02. Cone driver A03 can be a mount for holding and driving cone gears “A04” to revolve about a main shaft “A11” of a wheel.

A plurality of cone gears A04 can be rotatably mounted between the cone driver A03 and a cone holder A06 coupled with the cone driver A03. Cone gears A04 can be rotational cone-shaped gears that rotate while the cone driver “A03” is driving them. Each cone gear A04 may have a major conical surface and a minor frusto-conical surface provided at a larger end of the conical surface. Since surface “A04a” is pressing on a shifting shaft “A12” while revolving about the shaft “A11”, frictional force in between makes it rotate about its own axle.

A plurality of rods can be fixed to the cone holder A06 and the free ends of the rods can be inserted into corresponding holes formed on the cone driver A03 so as to form a plurality of free-end joints for joining the cone holder A06 to the cone driver A03. While the cone driver “A03” is rotating, the rotational force can be transmitted to the cone holder “A06” and drive the cone holder rotate as well about the main shaft A11.

A driven pad A07a may be frictionally engaged and rotatable with the frusto-conical surfaces of the cone gears A04, and a driven mount A07b may be coupled with the driven pad A07a. The main shaft A11 may be rotatable by the driven mount A07b. Main shaft A11 can be used to drive a bicycle wheel to rotate by connecting to the traditional wheel hub directly. It's the parts for transmitting rotational from the SVT system to the bicycle wheel.

Driven pad A07a can be driven by cone gears “A04”. It rotates about the shaft “A11” while surface of the cone gear “A04b” is pressed on it. The other function of the driven pad is to transmit rotational force to the satellite driving gear “A08” which is coupled on it.

Driven mount A07b can be rotated by driven pad “A07a” about the shaft “A11”. The Satellite driving gear “A08” can be attached on it. While it is revolving, power can be transmitted to the satellite driven gear “A09” by driving gear “A08”.

The shifting shaft A12 may have at one end thereof an outwardly extending annular flange frictionally engaged with the conical surfaces of the cone gears A04 at a plurality of contact points. The shifting shaft A12 can be shiftable in an axle direction by a set of gears to thereby change the position of the contact points.

The set of gears A13 may include an internal gear A13d having external threads threadably engaged with internal threads formed in the shifting shaft A12, a motor gear A13a driven by a motor and meshed between the internal gear A13d and a central gear A13c. When the motor is activated to drive the motor gear A13a to rotate clockwise, the internal gear A13d rotates clockwise and the shifting shaft A12 shifts away from the cone holder A06. When the motor is activated to drive the motor gear A13a to rotate anticlockwise, the internal gear A13d rotates anticlockwise and the shifting shaft A12 shifts towards the cone holder A06.

The driven mount A07b may be coupled with the main shaft A11 through a satellite gearing system. The satellite gearing system may include a satellite driving gear A08 attached to the driven mount A07b, a plurality of satellite driven gears A09 rotatable respectively about a plurality of supplementary shafts fixed on a plurality of blades extending radially from the main shaft A11, and a satellite internal gear A10 mounted in a housing. The driving gear A08 is adapted to mesh with and drive the driven gears A09 meshing with the satellite internal gear A10.

Shifting shaft A12 can be driven by the set of gears and shift parallel to the axle direction without rotation. Reaction force is provided to the cone “A04” by it. The shifting of its position is to change the contact points to the conical surface of the cone gears “A04”. Due to the infinite diameter change along the cross section area of the cone, the infinite gear ratio can be obtained by shifting the contact point.

The set of gears A13 can be used for gearing-up and magnifying the force for shifting the position of the shaft “A12”. A mini-motor with a micro-controller or a manual wiring system can be used for driving it.

Fixer C01 can be used to hold the gear “A10” and prevent it to be rotated by joining cases “C02” and “C03”.

System case C02 can be used to protect the mechanism inside and transmit the holding force from fixer “C01” to “C03”. It is easy to be changed as it is designed to be tailor-made by customer. Self-selected printing can be printed on the case. Normally, there are several number of shape and outlook can be selected.

Satellite fixed gear case C03 can be used to fix the gear “A10” by the holding force from fixer “C01”.

### Operation (Ref. to FIGS. 20-32)

The operation of SVT is mainly divided into three parts, namely Shifting Mechanism, SVT system and Satellite Gearing System. They are moving in “driving and driven” relationship by gears provided between them.

### 1. Shifting Mechanism (Ref. to FIGS. 20 and 343)

The mechanism of the SVT shifts the contact points of the shifting shaft “A12” and the cone gears “A04” on that various gearing ratios can be obtained. Bluetooth transmission technology can be used for controlling the shifting mechanism and the speedometer. As the speed is sensed and transmitted to the mobile phone app, the program set on the app will decide the gearing ratio to be used. Relevant signal will be transmitted to the controller and actuating the motor to drive the shaft and the gear A13a.

When gear “A13a” rotates, gear “A13b” will be driven to rotate in the same direction by connection to gear “A13c”. As gear “A13d” is connected to “A13a” and “A13b”, it rotates about the axis and drives the shifting shaft “A12” to move along axial direction through the threads in between. Therefore the contact points can be shifted.

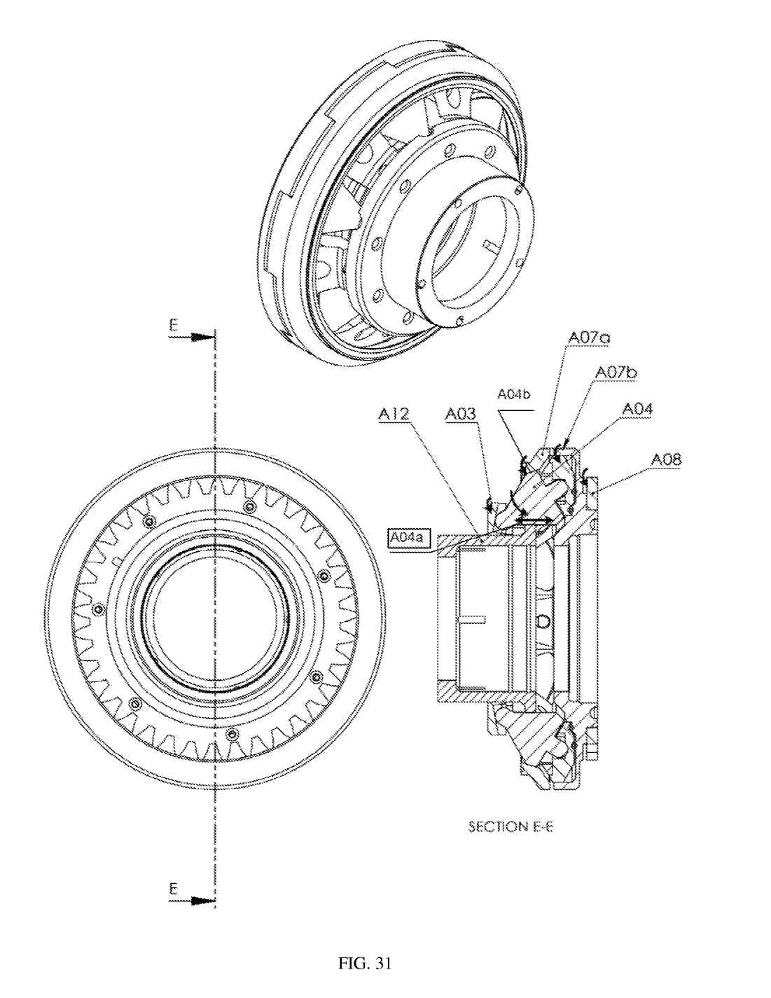

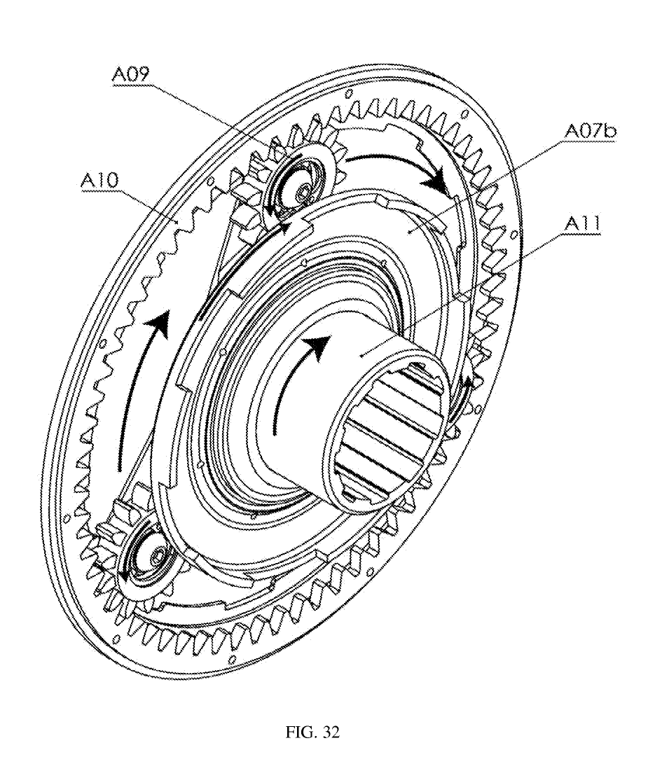

### 2. SVT System (Ref. to FIGS. 31 and 342)

SVT stands for smart variable transmission. It uses cone-shaped gears “A04” for power transmission. As the cross sectional area of a cone is infinite, by making contact to points of the conical surface, different gear ratios can be obtained.

By shifting the contact points between the shaft “A12” and the cone gears “A04”, various rotational speeds of the cone gears “A04” can be obtained. It directly drives the rotation of the driven pad “A07a” and the mount “A07b”. Therefore gear ratio can be obtained during the process.

### 3. Satellite Gearing (Ref. to FIGS. 31 and 341)

Satellite Gearing is used for transmitting power from SVT to the bicycle wheel. It helps to reduce frictional force required for the “driving and driven” process in the SVT. Power transmitted from SVT can be magnified and stepped up to drive the wheel to rotate.

Micro-controlling Unit “MCU” is the brain to control the position of the shifting shaft by responding speed, slope and stepping force that are detected by sensors. There may be two controlling methods for the system. One method is based on program preset on the built-in MCU, while the other one is the use of mobile phone app through the connection by Bluetooth 4.0 technology.

Once the SVT system has been installed, it can be with or without mobile connection or not. With mobile app connected, advanced functions of the SVT can be used as advanced features and calculation can be set on the app.

### Without Mobile App

SVT is mainly controlled by a program set on the built-in MCU. SVT is an infinite gear transmission system. The number of gear ratio it can be equipped with depends on the program set on the MCU. Without mobile connected, the system can be equipped with preset number of intervals of gear ratios. For example, 6 intervals can be set between 0-1. That means 0, 0.2, 0.4, 0.6, 0.8, 1 of the position of the shifting shaft “A12” where position “0” and “1” is the minimum and maximum point of the shifting range respectively. The “0” position of the shifting shaft “A12” is the gear ratio that less force is required but lower speed is resulted, while position “1” is the gear ratio that stronger force is required but higher speed is resulted.

### With Mobile App

With mobile connected, higher and advanced performance of the SVT can be used as mobile phone is powerful nowadays. With smart phone connected, it will take over the role of MCU (Machine Control Unit). With smart element involved, the SVT can function in a more humanity way. For example, it may involve number of gear ratio interval to be set, gear changing habit, real time human understandable response shown on the mobile screen, and data sharing through the internet etc.

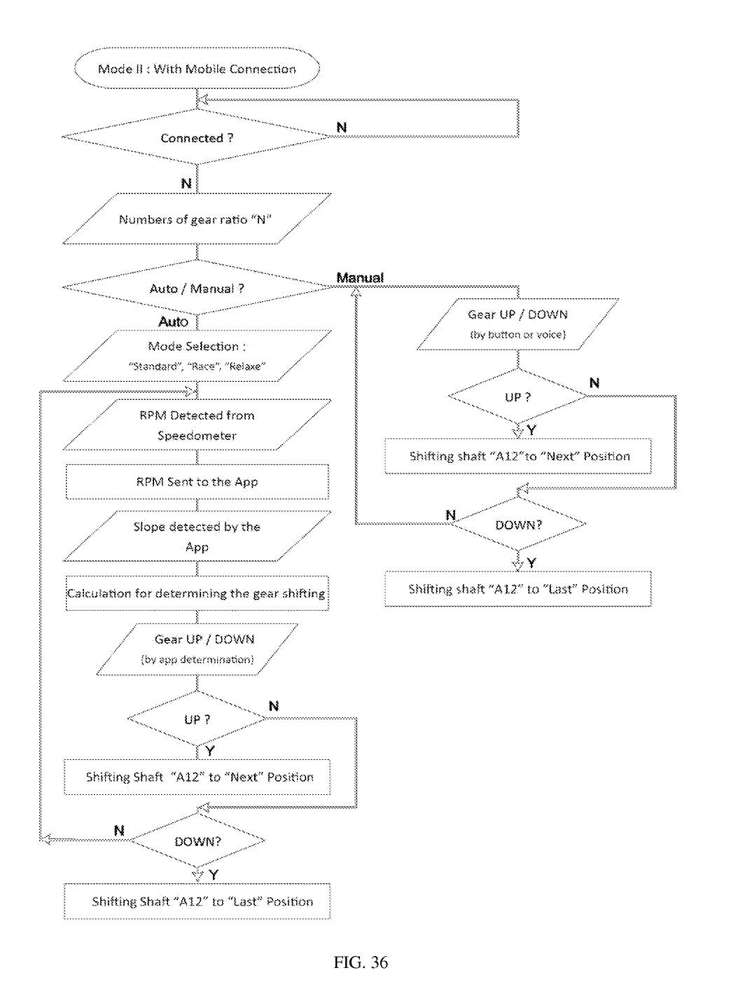

Controlling Process without Smart Phone Connection (Flow Chart in FIG. 36)

The controlled part is about the position shifting of the Shifting Shaft “A12”. Shifting the position of the Shifting Shaft “A12”, a programmed MCU, built-in on the system controller, is used. Signal will be sent to the motor which is attached to the gear “A13a” to rotate clockwise or anti-clockwise for shifting the position of the shifting shaft “A12”.

As shown in the flow chart, “0-1” is the interval reference of the position of the shifting shaft “A12”. “0” represents the lowest gear ratio while “1” represents the highest gear ratio. Lower gear ratio provides slower rotation speed output but less force is required, while higher gear ratio provides higher rotation speed output but stronger force is required.

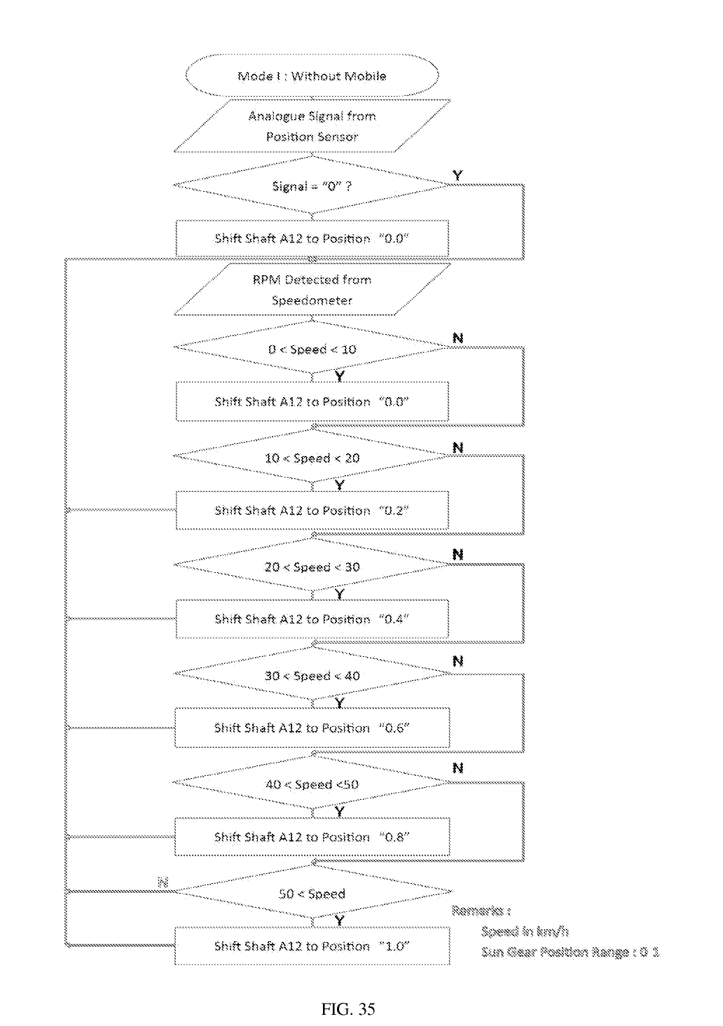

Controlling Process with Smart Phone Connection (Flow Chart in FIG. 35)

With Smart Phone connected, advanced functions and performance of the SVT can be used. As the moving habit of the shifting shaft “A12” is directly responding to the riding performance such as speed, force, efficiency, suitability and so on. Therefore the more variation of the habit the SVT is equipped with, the more powerful it can perform. Smart phones nowadays are much powerful than before. It is similar to a mini computer that can handle great deal of data processing. Using a smart phone connected to the SVT, it will take over the role of MCU. By designing an app for controlling the SVT, much more running processes can be handled and therefore SVT can function in a more humanity way and can become more interactive.

Humanity or so called “Smart” depends on the program designed for the app. The basic function of the app is similar to the program set on the MCU, i.e. controlling the signal sent to the motor which is connected to the gear “A13a”. But the program will be much more complicated by analyzing a large amount of data collected and adjusting the position of the shifting shaft “A12” more precisely.

Data such as speed, slope and position of the shifting shaft “A12” will be collected by relevant sensors. Analyzing of those data is a real time process based on the criteria preset by users. Since it is a variable transmission gear box, criteria such as numbers of interval of the gear ratio, gears changing habit can be customized by users. The program we designed will make calculation based on equations with those collected data and customized variables to determinate the time for shifting the shifting shaft “A12” to an appropriate position along the main shaft “A11”. Therefore various gear ratios can be obtained.

With the smart phone connected, not only the automatic transmission can be used, manual transmission can also be selected if users prefer to use. For the manual mode, users can change gear ratios through the app interface. Through the app interface, there are several buttons provides for shifting gear ratios such as “UP” or “DOWN”. Once a button is triggered, the app sends a signal to the MCU built-in on the SVT to shift the position of the shifting shaft “A12”.

For providing a wide range of gear changing methods, voice recognition can be provided. By using voice recognition, users speak to the microphone with designated commands, for example “GEAR UP”, “GEAR DOWN”. Shifting command can be triggered by voice. No physical touching is needed for riders. By notifying users about the status of the bike or the gear box, various views can be designed on the apps. Users can select the information they are interested and display on the mobile during bike riding. Information such as speed, slope, location, gear ratio, riding path, distance etc. can be selected.

As the system is equipped with lights, once the smart phone is connected, it lights up automatically at night for safety. Users can switch those lights on or off through the app.

Since smart phone can be connected to the internet, users can share their riding data to a cloud server. With data collected in real time, the SVT can be controlled or followed by server. For racing games or group games, the performance can be reported or recorded down anytime with relevant login.

While the variable transmission gearing system has been shown and described with particular references to a number of preferred embodiments thereof, it should be noted that various other changes or modifications may be made without departing from the scope of the appended claims.

1. A variable transmission gearing system for a bicycle, the system comprising:
(a) a mainboard driven by a chain gear;
(b) a plurality of cone gears rotatable on a plurality of shafts fixed on the mainboard respectively, each cone gear comprising a ratio gear and a driven gear, the driven gear being meshed with a first internal spur gear mounted in a gear box; and
(c) a central sun gear rotatable with an input shaft of a wheel for driving the wheel to rotate, the sun gear being meshed with the ratio gears of the cone gears, and adapted to be shifted in an axle direction along the input shaft by a plurality of threaded rods;
wherein when the chain gear is rotated anticlockwise, the mainboard and the cone gears rotate anticlockwise and drive the sun gear and the input shaft to rotate clockwise.

2. The variable transmission gearing system as claimed in claim 1, further comprising a set of magnetic clutch gears meshed with a set of intermediate gears for driving the threaded rods, the magnetic clutch gears comprising a shifting gear and fixed gear sandwiched between first and second coils and rotatable on a pin fixed on the mainboard, the first coil being fixed on the mainboard, the fixed gear being mounted on the second coil and meshed with the first internal spur gear, and the shifting gear being shiftable along the pin between the fixed gear and the first coil, wherein when the shifting gear is paired with the fixed gear, the shifting gear rotates anticlockwise and drives the threaded rods to rotate anticlockwise so that the sun gear moves towards the mainboard, and when the shifting gear is paired with the first coil, the threaded rods rotate clockwise, and the sun gear moves away from the mainboard.

3. The variable transmission gearing system as claimed in claim 2, wherein the set of intermediate gears comprises an outer gear meshed with the shifting gear, a ring gear having outer teeth meshed with the outer gear and inner teeth meshed with an inner gear fixed on each threaded rod.

4. The variable transmission gearing system as claimed in claim 1, further comprising one or more generators each having a gear meshed with a second internal spur gear mounted in the gear box to generate electricity.

5. The variable transmission gearing system as claimed in claim 2, further comprising a speedometer for collecting rotational speed data which will be transmitted to a mobile phone app for calculation and control of the sun gear.

6. The variable transmission gearing system as claimed in claim 2, further comprising a Bluetooth controller to carry out control and data transmitting requests.

7. The variable transmission gearing system as claimed in claim 2, further comprising a built-in machine control unit which is set with a program to control position of the sun gear.

8. The variable transmission gearing system as claimed in claim 2, further comprising a mobile phone app adapted to carry out real time analysis of data including speed, slope and position of the sun gear detected by a sensor in order to control the position of the sun gear.

9. The variable transmission gearing system as claimed in claim 1, wherein a plurality of bearings is provided between the mainboard and the input shaft.

10. The variable transmission gearing system as claimed in claim 1, wherein three cone gears are rotatable on three shafts fixed on the mainboard respectively.

11. A variable transmission gearing system for a bicycle, the system comprising:
(a) a sprocket mounted on a sprocket mount;
(b) a cone driver rotatable with the sprocket mount;
(c) a plurality of cone gears rotatably mounted between the cone driver and a cone holder coupled with the cone driver, each cone gear comprising a major conical surface and a minor frusto-conical surface formed at a larger end of the major conical surface;
(d) a driven pad frictionally engaged and rotatable with the frusto-conical surfaces of the cone gears;
(e) a main shaft of a wheel rotatable with the driven pad; and
(f) a shifting shaft having at one end thereof an outwardly extending annular flange frictionally engaged and rotatable with the conical surfaces of the cone gears at a plurality of contact points, wherein the shifting shaft is shiftable in an axle direction by a set of gears to thereby change the position of the contact points.

12. The variable transmission gearing system as claimed in claim 11, wherein the set of gears comprises an internal gear having external threads threadably engaged with internal threads formed in the shifting shaft, a motor gear driven by a motor and meshed between the internal gear and a central gear; wherein when the motor is activated to drive the motor gear to rotate clockwise, the internal gear rotates clockwise and the shifting shaft shifts away from the cone holder, and when the motor is activated to drive the motor gear to rotate anticlockwise, the internal gear rotates anticlockwise and the shifting shaft shifts towards the cone holder.

13. The variable transmission gearing system as claimed in claim 11, wherein the main shaft of the wheel is rotatable with the driven pad through a driven mount coupled with the driven pad.

14. The variable transmission gearing system as claimed in claim 13, wherein the driven mount is coupled with the main shaft through a satellite gearing system, the satellite gearing system comprising a satellite driving gear attached to the driven mount, a plurality of satellite driven gears rotatable respectively about a plurality of supplementary shafts fixed on a plurality of blades extending radially from the main shaft, and a satellite internal gear mounted in a housing, wherein the driving gear is adapted to mesh with and drive the driven gears meshing with the satellite internal gear.

15. The variable transmission gearing system as claimed in claim 11, wherein the sprocket mount is annular and formed with a plurality of openings, and the cone driver is coupled with the sprocket mount by a plurality of balls provided thereinbetween.

16. The variable transmission gearing system as claimed in claim 11, wherein a plurality of rods is fixed to the cone holder and the free ends of the rods are inserted into corresponding holes formed on the cone driver to form a plurality of free-end joints for joining the cone holder to the cone driver.

17. The variable transmission gearing system as claimed in claim 11, further comprising a speedometer for collecting rotational speed data which will be transmitted to a mobile phone app for calculation and control of the shifting shaft.

18. The variable transmission gearing system as claimed in claim 12, further comprising a built-in machine control unit which is set with a program to control position of the shifting shaft by sending signals to the motor to rotate the motor gear clockwise or anticlockwise.

19. The variable transmission gearing system as claimed in claim 11, further comprising a mobile phone app adapted to carry out real time analysis of data including speed, slope and position of the shifting shaft detected by a sensor in order to control position of the shifting shaft.

20. The variable transmission gearing system as claimed in claim 12, further comprising at least one more gear meshed between the internal gear and the central gear.
